(19) United States
(12) Patent Application Publication
(10) Pub. No.: US 2026/0014422 A1
(43) Pub. Date: Jan. 15, 2026

(54) APPARATUS AND METHOD FOR AUTOMATIC FITNESS CONTENT GENERATION USING ARTIFICIAL INTELLIGENCE (AI)

(71) Applicant: Anytime Movement LLC, Nashua, NH (US)

(72) Inventor: James L. Jacobs, II, Nashua, NH (US)

(73) Assignee: Anytime Movement LLC, Nashua, NH (US)

(21) Appl. No.: 19/265,235

(22) Filed: Jul. 10, 2025

Related U.S. Application Data
(60) Provisional application No. 63/669,901, filed on Jul. 11, 2024.

(51) Int. Cl. A63B 24/00; G06N 20/00

(52) U.S. Cl. CPC A63B 24/0075; A63B 24/0006; A63B 24/0087; G06N 20/00; A63B 2024/0096

(57) ABSTRACT

Apparatus and method for automatic fitness content generation using artificial intelligence (AI) are disclosed. The apparatus includes at least a processor and a memory communicatively connected to the at least a processor, wherein the memory contains instructions configuring the at least a processor to receive user data and class data, wherein the user data includes a user prompt, generate at least a fitness content using a content machine-learning model of a machine-learning module as a function of the class data and the user data, adjust at least a content parameter of the at least a fitness content as a function of the user prompt and transmit the at least a fitness content to at least a user device.

This application claims the benefit of priority of U.S. Provisional Patent Application Ser. No. 63/669,901, filed on Jul. 11, 2024, and titled “APPARATUS AND METHOD FOR AUTOMATIC FITNESS CONTENT GENERATION USING ARTIFICIAL INTELLIGENCE (AI),” which is incorporated by reference herein in its entirety.

### FIELD OF THE INVENTION

The present invention generally relates to the field of artificial intelligence. In particular, the present invention is directed to an apparatus and method for automatic fitness content generation using artificial intelligence.

### BACKGROUND

In recent years, there has been a growing interest in health and fitness, driven by an increasing awareness of the importance of physical activity in maintaining overall well-being. While these existing fitness solutions offer a variety of workout routines, exercises, and training plans, they often lack personalization and customization.

### SUMMARY OF THE DISCLOSURE

### [to be Completed Upon Selection of Claims.]

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 illustrates a block diagram of an exemplary apparatus for automatic fitness content generation using artificial intelligence;

FIG. 2 illustrates an exemplary user device displaying a fitness content;

FIG. 3 illustrates a block diagram of an exemplary fitness database;

FIG. 4 illustrates a block diagram of an exemplary chatbot system;

FIG. 5 illustrates a block diagram of an exemplary fuzzy set system;

FIG. 6 illustrates a block diagram of exemplary embodiment of a machine-learning module;

FIG. 7 illustrates a diagram of an exemplary nodal network;

FIG. 8 illustrates a block diagram of an exemplary node;

FIG. 9 illustrates a flow diagram of an exemplary method for automatic fitness content generation using aritivicial intelligence; and

FIG. 10 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to apparatuses and methods for automatic fitness content generation using artificial intelligence (AI). The apparatus includes at least a processor and a memory communicatively connected to the at least a processor, wherein the memory contains instructions configuring the at least a processor to receive user data and class data, wherein the user data includes a user prompt, generate at least a fitness content using a content machine-learning model of a machine-learning module as a function of the class data and the user data, wherein generating the at least a fitness content includes generating content training data, wherein the content training data comprises correlations between exemplary user data, exemplary class data, and exemplary fitness contents, training the content machine-learning model using the content training data and generating the at least a fitness content using the trained content machine-learning model, adjust at least a content parameter of the at least a fitness content as a function of the user prompt and transmit the at least a fitness content to at least a user device. Exemplary embodiments illustrating aspects of the present disclosure are described below in the context of several specific examples.

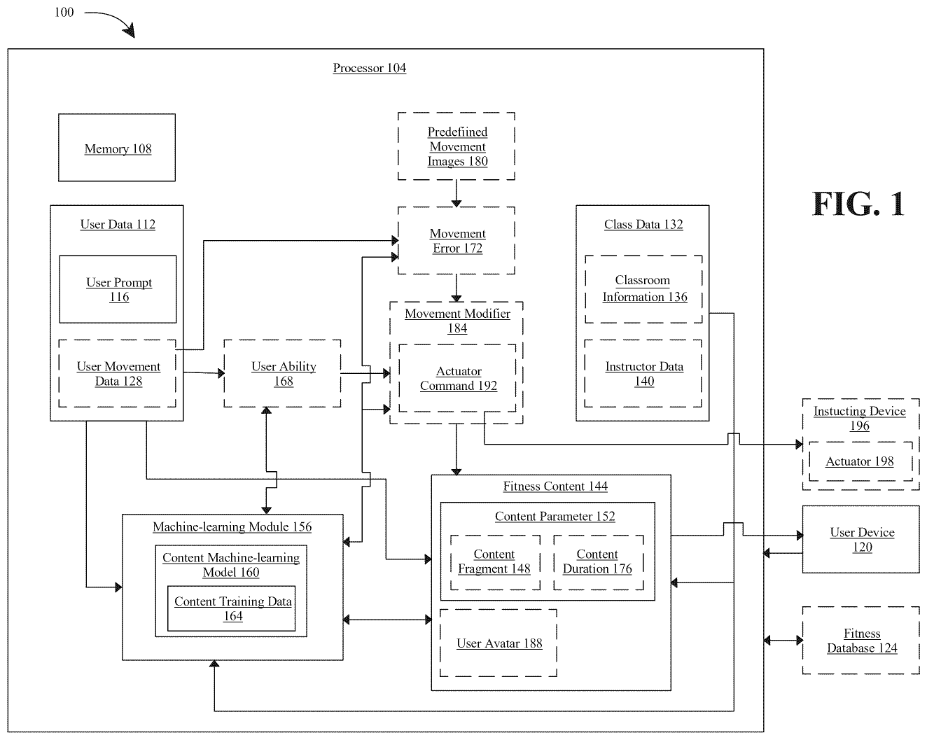

Referring now to FIG. 1, an exemplary embodiment of an apparatus 100 for automatic content generation is illustrated. Apparatus 100 includes at least a processor 104. Processor 104 may include, without limitation, any processor described in this disclosure. Processor 104 may be included in a computing device. Processor 104 may include any computing device as described in this disclosure, including without limitation a microcontroller, microprocessor, digital signal processor (DSP) and/or system on a chip (SoC) as described in this disclosure. Processor 104 may include, be included in, and/or communicate with a mobile device such as a mobile telephone or smartphone. Processor 104 may include a single computing device operating independently, or may include two or more computing device operating in concert, in parallel, sequentially or the like; two or more computing devices may be included together in a single computing device or in two or more computing devices. Processor 104 may interface or communicate with one or more additional devices as described below in further detail via a network interface device. Network interface device may be utilized for connecting processor 104 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Processor 104 may include but is not limited to, for example, a computing device or cluster of computing devices in a first location and a second computing device or cluster of computing devices in a second location. Processor 104 may include one or more computing devices dedicated to data storage, security, distribution of traffic for load balancing, and the like. Processor 104 may distribute one or more computing tasks as described below across a plurality of computing devices of computing device, which may operate in parallel, in series, redundantly, or in any other manner used for distribution of tasks or memory between computing devices. Processor 104 may be implemented, as a non-limiting example, using a “shared nothing” architecture.

With continued reference to FIG. 1, processor 104 may be designed and/or configured to perform any method, method step, or sequence of method steps in any embodiment described in this disclosure, in any order and with any degree of repetition. For instance, processor 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Processor 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 1, apparatus 100 includes a memory 108 communicatively connected to processor 104. For the purposes of this disclosure, “communicatively connected” means connected by way of a connection, attachment or linkage between two or more relata which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

With continued reference to FIG. 1, memory 108 contains instructions configuring processor 104 to receive user data 112. For the purposes of this disclosure, “user data” is data that is related to a user who takes or will take a fitness class. For the purposes of this disclosure, a “user” is any person, group or entity who wants to take or is taking a fitness class. In some embodiments, a user may include a plurality of users. As a non-limiting example, a plurality of users may be taking the same fitness class. For the purposes of this disclosure, a “fitness class” is a class for any type of physical exercise. As a non-limiting example, fitness class may include a dancing class, ballroom dancing class, Zumba class, aerobics class, circus techniques class, gymnastics class, Pilates class, kettlebell workouts class, circuit workouts class, partner-based exercises class, martial arts class, wrestling class, CrossFit class, boxing class, jiujitsu class, judo class, karate class, kung fu class, taekwondo class, hapkido class, Silat class, Escrima class, Arnis class, Kali class, boxing class, Muay Thai class, kickboxing class, tai chi class, yoga such as but not limited to hatha class, vinyasa class, Bikram class, restorative class, yin class, ashtanga class, Iyengar class, hot yoga class, Tai chi class, sports related class, and the like. In an embodiment, fitness class may include a prerecorded class. In another embodiment, fitness class may include a real-time live class. In some embodiments, fitness class may include an in-person class. In some embodiments, fitness class may include a virtual class.

With continued reference to FIG. 1, in some embodiments, user data 112 may include a format of text, icon, image, animation, audio, and the like. In some embodiments, user data 112 may include a plurality sets of user data 112 from plurality of users. As a non-limiting example, one or more users may input user data 112 at the same time, at different times, or the like. User data 112 includes a user prompt 116. For the purposes of this disclosure, a “user prompt” is a data input or command provided by a user to a computer system, software application, or interface. In some embodiments, user prompt 116 may include a format of text, audio or image. For example, and without limitation, user may input user prompt 116 using a chatbot as described below. For the purposes of this disclosure, “chatbot” is an artificial intelligence (AI) program designed to simulate human conversation or interaction through text, voice-based or image-based communication. For example, and without limitation, user may input user prompt 116 using a microphone of a user device 120 as described below. As a non-limiting example, user prompt 116 may include a request for fitness class modification, request for positions or movements (e.g., class action as described below) modification or replacement, question related to fitness class, positions or movements, or the like. For example, and without limitation, user prompt 116 may include “could you please let me hold the Down Dog for a while longer?” or “is it possible to put a Warrior pose in the sequence today as well as crow balancing?” For example, and without limitation, user prompt 116 may include “could you please check my position?” or “could you explain or demonstrate more detail about the previous position?” In some embodiments, user prompt 116 may be stored in fitness database 124. In some embodiments, processor 104 may retrieve user prompt 116 from fitness database 124 or user may manually input user prompt 116 into processor 104.

With continued reference to FIG. 1, in some embodiments, user data 112 may include user information. For the purposes of this disclosure, “user information” is information related to a user's personal details. As a non-limiting example, user information of user data 112 may include age, gender, name, athletic abilities, fitness experience, fitness goals, fitness history, diet goals, diet history, injury history, medication history, and the like. Persons skilled in the art, upon reviewing the entirety of this disclosure, may appreciate various user information that may be used as user data 112.

With continued reference to FIG. 1, in some embodiments, user data 112 may include a class preference For the purposes of this disclosure, a “class preference” is a preference of a user related to a fitness class. As a non-limiting example, class preference of user data 112 may include a preference for a specific fitness class, specific time of the fitness class, specific duration of the fitness class, a specific instructor for the fitness class, a specific class day for the fitness class, and the like. For example and without limitation, the specific fitness class of class preference may include the preference of the user that the user prefers to take hot yoga classes. For another example and without limitation, the specific fitness class of class preference may include the preference of the user that the user prefers to take an ashtanga class and a Pilates class. For example and without limitation, the specific time of the fitness class of class preference may include the preference of the user that the user prefers to take the fitness class in the morning, afternoon, evening, midnight, and the like. For another example and without limitation, the specific time of the fitness class of class preference may include the preference of the user that the user prefers to take the fitness class at 5 a.m., 8 a.m., 12 p.m. 3 p.m. 11 p.m., 2 a.m., and the like. For example and without limitation, the specific duration of the fitness class of class preference may include the preference of the user that the user prefers to take the fitness class that includes a class duration of 15 mins, 30 mins, 45 mins, 60 mins, 90 mins, 120 mins, and the like. For example and without limitation, the specific day for the fitness class of class preference may include the preference of the user that the user prefers to take the fitness class on Monday, Tuesday, Wednesday, Thursday, Friday, Saturday, Sunday, and/or any combination of the days such as but not limited to Monday and Wednesday, Tuesday and Friday, Saturday and Sunday, and the like. For example and without limitation, the specific instructor for the fitness class of class preference may include the preference of the user that the user prefers to take the fitness class that is taught by a specific instructor with, such as but not limited to a specific name, a specific fitness experience, a specific gender, a specific teaching experience, and the like.

With continued reference to FIG. 1, in some embodiments, user data 112 may include user movement data 128. In some embodiments, processor 104 may be configured to receive user movement data 128. As used herein, “user movement data” is an image or video element of a user moving in a fitness class. As a non-limiting example, user movement data 128 may include image, video, audio, or or the like of user's poses, motions, facial expressions, speech, and the like. For example, and without limitation, user movement data 128 may include an image of a user in a specific position while taking a fitness class. For example, and without limitation, user movement data 128 may include a video of a user taking a fitness class. In some embodiments, processor 104 may receive real-time user movement data 128 from an ongoing fitness class. In some embodiments, processor 104 may receive historical user movement data 128, such as data from a prerecorded training session of users.

With continued reference to FIG. 1, in some embodiments, apparatus 100 may include fitness database 124. As used in this disclosure, “fitness database” is a data structure configured to store data associated with a fitness class and a user. In one or more embodiments, fitness database 124 may include input or calculated information and data related to the fitness class and user. A datum history may be stored in fitness database 124. The datum history may include real-time and/or previous input class data 132 and/or user data 112. Processor 104 may be communicatively connected with fitness database 124. For example, and without limitation, in some cases, fitness database 124 may be local to processor 104. In another example, and without limitation, fitness database 124 may be remote to processor 104 and communicative with processor 104 by way of one or more networks. A network may include, but is not limited to, a cloud network, a mesh network, and the like. By way of example, a “cloud-based” system can refer to a system which includes software and/or data which is stored, managed, and/or processed on a network of remote servers hosted in the “cloud,” e.g., via the Internet, rather than on local severs or personal computers. A “mesh network” as used in this disclosure is a local network topology in which the infrastructure processor connects directly, dynamically, and non-hierarchically to as many other computing devices as possible. A “network topology” as used in this disclosure is an arrangement of elements of a communication network. Network may use an immutable sequential listing to securely fitness database 124. An “immutable sequential listing,” as used in this disclosure, is a data structure that places data entries in a fixed sequential arrangement, such as a temporal sequence of entries and/or blocks thereof, where the sequential arrangement, once established, cannot be altered or reordered. An immutable sequential listing may be, include and/or implement an immutable ledger, where data entries that have been posted to the immutable sequential listing cannot be altered.

With continued reference to FIG. 1, in some embodiments, fitness database 124 may include keywords. As used in this disclosure, a “keyword” is an element of word or syntax used to identify and/or match elements to each other. For example, without limitation, the keyword may include “a name of the specific position in yoga” in the instance that a user is looking for information related to specific yoga position. In another non-limiting example, the keyword may include “a name of sports or fitness class” in the instance that a user is looking for information related to specific sports or fitness class.

With continued reference to FIG. 1, database may be implemented, without limitation, as a relational database, a key-value retrieval database such as a NOSQL database, or any other format or structure for use as a database that a person skilled in the art would recognize as suitable upon review of the entirety of this disclosure. Database may alternatively or additionally be implemented using a distributed data storage protocol and/or data structure, such as a distributed hash table or the like. Database may include a plurality of data entries and/or records as described above. Data entries in a database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in a database may store, retrieve, organize, and/or reflect data and/or records as used herein, as well as categories and/or populations of data consistently with this disclosure.

With continued reference to FIG. 1, in some embodiments, processor 104 may receive user data 112 from at least a user device 120. For the purposes of this disclosure, a “user device” is a device that a user uses for a fitness class. As a non-limiting example, user device 120 may include a smartphone, laptop, tablet, smart watch, smart glasses, and the like. As another non-limiting example, user device 120 may include a wired or wireless mouse, a touchpad, a touchscreen, a game controller, keyboard, microphone, and the like. In some embodiments, the user device 120 may include one or more user devices 120 that may be used by one or more users. As a non-limiting example, each of one or more users may use each of one or more user device 120 to input user data 112. For example and without limitation, each of the one or more user may use a smartphone touch screen to input user data 112. As another non-limiting example, user may input user data 112 using a microphone of user device 120. In some embodiments, user may input user information, user prompt 116, class preference, user movement data 128, and the like using a user device 120.

With continued reference to FIG. 1, processor 104 may be configured to receive user data 112 from a camera in a fitness classroom or user device 120. As used in this disclosure, a “camera” is a device that is configured to sense electromagnetic radiation, such as without limitation visible light, and generate an image representing the electromagnetic radiation. In some embodiments, processor 104 may receive user movement data 128 from a camera installed in a fitness classroom. In some embodiments, processor 104 may receive user movement data 128 from a camera installed in user device 120.

With continued reference to FIG. 1, memory 108 contains instructions configuring processor 104 to receive class data 132. For the purposes of this disclosure, “class data” is information related to a fitness class. In some embodiments, class data 132 may include a format of text, icon, image, animation, audio, and the like. In some embodiments, class data 132 may be stored in a fitness database 124. In some embodiments, class data 132 may be retrieved from fitness database 124. In some embodiments, user or instructor may manually input class data 132 into processor 104.

With continued reference to FIG. 1, in some embodiments, class data 132 may include class information 136. For the purposes of this disclosure, “class information” is information related to a fitness class. As a non-limiting example, class information 136 may include a type of a fitness class, a name of the fitness class, class review, class attendance history, class capacity, class time, class date, class duration, current number of (count of) users wanting the fitness class, lighting setup for the fitness class, temperature setup for the fitness class, and the like. Persons skilled in the art, upon reviewing the entirety of this disclosure, may appreciate various class information that may be used as class information 136. In some embodiments, class information 136 may include image or video of fitness class. In some embodiments, class information 136 may include description of fitness class. As a non-limiting example, In some embodiments, class information 136 may include classroom information. For the purposes of this disclosure, “classroom information” is information related to a fitness classroom of a fitness class. As a non-limiting example, the classroom information of the class information 136 may include a size of the fitness classroom, temperature range that the fitness classroom can control, lighting of the fitness classroom, a location of the fitness classroom, interior design of the fitness classroom, accessibility for a disabled user, and the like. In some embodiments, fitness classroom may be user's personal room. For example and without limitation, the location of the fitness classroom of the classroom information may include address of the fitness classroom, which floor of a building the fitness classroom is at, and the like. For another example and without limitation, the accessibility for the disabled user of the classroom information may include if the building the fitness classroom is at has stairs, elevators, ramps, which floor of the building the fitness classroom is at, and the like. Persons skilled in the art, upon reviewing the entirety of this disclosure, may appreciate various classroom information that may be used as class information 136.

With continued reference to FIG. 1, in some embodiments, class data 132 may include instructor data 140. For the purposes of this disclosure, “instructor data” is data related to an instructor of a fitness class. As a non-limiting example, instructor data 140 may include a name of an instructor of the fitness class, instructor gender, a name of other classes an instructor teaches, instructor fitness experience, instructor teaching experience, or the like. For the purposes of this disclosure, an “instructor” is any person that teaches a fitness class. In some embodiments, instructor may include one or more instructors. As a non-limiting example, one or more instructors may include one or more instructors that teach different fitness classes.

With continued reference to FIG. 1, in an embodiment, processor 104 may retrieve class data 132 from fitness database 124. In another embodiment, processor 104 may receive class data 132 from an instructor. In some embodiments, instructor may use an instructor device to input class data 132. For the purposes of this disclosure, “instructor device” is a device that an instructor uses for a fitness class. As a non-limiting example, instructor device may include a smartphone, laptop, tablet, smart watch, and the like. In some embodiments, instructor device may be consistent with user device 120. For example and without limitation, instructor may input class data 132 on instructor device by typing on the keyboard. For another example and without limitation, instructor may input class data 132 on instructor device by touching the touch screen.

With continued reference to FIG. 1, additional disclosure related to user data 112 and class data 132 may be found in U.S. patent application Ser. No. 18/368,915, filed on Sep. 15, 2023, and titled “APPARATUS FOR CLASSROOM SCHEDULING AND METHOD OF USE,” having an attorney docket number of 1455-003USU1, the entirety of which is hereby incorporated by reference.

With continued reference to FIG. 1, memory 108 contains instructions configuring processor 104 to generate at least a fitness content 144. For the purposes of this disclosure, a “fitness content” is the instruction provided during a fitness class for a user. As a non-limiting example, fitness content 144 may include text, audio, icon, image, video, animation, or the like. For example, and without limitation, fitness content 144 may include a plurality of videos of an instructor giving instructions on how to make a specific pose for a yoga class. For example, and without limitation, fitness content 144 may include an audio and a sequence of images that explains how to make a specific pose for a yoga class. In some embodiments, fitness content 144 may be stored in fitness database 124. In some embodiments, processor 104 may retrieve fitness content 144 from fitness database 124 or user or instructor may manually input fitness content 144 into processor 104.

With continued reference to FIG. 1, in some embodiments, fitness content 144 may include a secondary fitness content. For the purposes of this disclosure, a “secondary fitness content” is a supplementary content to a fitness content that provides additional information or further context. In some embodiments, secondary fitness content may include text, audio, icon, image, video, animation, or the like. As a non-limiting example, secondary fitness content may include additional text description overlayed on a video of fitness content 144. As another non-limiting example, secondary fitness content may include additional video overlayed on an image of fitness content 144. In some embodiments, secondary fitness content may include a slow motion video. For the purposes of this disclosure, “slow motion video” is a video that is played more slowly than it was recorded. For example and without limitation, secondary fitness content may include a detailed body motion video of fitness content 144. For the purposes of this disclosure, “detailed body motion video” is a video that shows a portion of a body part that is needed to be focused on to show a detailed movement of the body part. As a non-limiting example, when the exercise is a squat, the detailed body motion video may include an animation video of glutes and thighs to show how the body parts move during the squat. Persons skilled in the art, upon reviewing the entirety of this disclosure, may appreciate various types of the detailed body motion video that may be used for secondary fitness content. In an embodiments, secondary fitness content may be received from fitness database 124. In some embodiments, instructor may manually input secondary fitness content into processor 104.

With continued reference to FIG. 1, as a non-limiting example, secondary fitness content may include secondary voice data. For the purposes of this disclosure, “secondary voice data” is supplementary audio information to a fitness content. As a non-limiting example, secondary voice data may include detailed instructions related to an exercise. For example and without limitation, the detailed instruction may include instructions related to exercise position, which part of a body to focus, which muscles to focus on, amount of time to do the exercise for the fitness class, any information about the exercise, or the like. As another non-limiting example, secondary voice data may include encouragement. In an embodiments, secondary voice data of secondary fitness content may be received from fitness database 124. In another embodiments, secondary voice data may be received from an instructor device.

With continued reference to FIG. 1, fitness content 144 disclosed herein may be consistent with fitness content 144 described in U.S. patent application Ser. No. 18/368,867, filed on Sep. 15, 2023, and titled “SYSTEMS AND METHODS FOR FITNESS CLASS GENERATION,” having an attorney docket number of 1455-002USU1, the entirety of which is hereby incorporated by reference. As used herein, a “fitness content 144” is audio or video that has been edited. For example, fitness content 144 may include audio or video containing two or more elements of user movement data 128 that do not form a single continuous video or audio recording from a single perspective (such as due to being edited together). In some embodiments, user movement data 128 disclosed herein may be consistent with content fragments 148 of content parameter 152 described in the entirety of this disclosure. Generating fitness content 144 may include rearranging fragmented user movement data 128 as described above. For example, computing device may be configured to order, remove, or otherwise rearrange modular sections of a recorded training session.

With continued reference to FIG. 1, additionally, fitness content 144 or secondary fitness content disclosed herein may be consistent with instructions data described in U.S. patent application Ser. No. 18/368,947, filed on Sep. 15, 2023, and titled “APPARATUS FOR CLASS ADMINISTRATION AND A METHOD OF USE,” having an attorney docket number of 1455-004USU1, the entirety of which is hereby incorporated by reference. For example, instructions data may include data relating to kickboxing class. Instructions data may include instructions on how to perform a specific activity. For example, instructions data may include instructions on how high to raise a user's leg when kickboxing. Instructions data may further include data relating any components necessary for proper participation of a class. For example, instructions data may include the type, size, height, or color of a yoga mat necessary for a yoga class. Instructions data may further include suggested instructions data wherein suggested instructions data is optional directions for participating in a class. for example, suggested instructions data may include a suggested speed on a treadmill, or a suggested incline. Suggested instructions data may further include a suggested temperature of the room or a suggested difficulty on an elliptical. Instructions data may further include instructions pose data wherein instructions pose data is instructions on how to achieve a specific pose necessary for the particular activity. Instructions data may further include instructions telling a user to speed up, slow down, or take a break. Instructions data may further include advice data, wherein advice data may advise a client how successful they are in participating in a class. instructions data may further include a plurality of data wherein the plurality of data corresponds to a plurality of steps. Instructions data may further include the type of class being instructed, the time necessary for the class and the like. Instructions data may further include data relating to the difficult level of the class. Instructions data may further include a plurality of steps wherein each step contains data relating to the amount of time the step should take. In some cases, instructions data may be used to signify to users the class that is being instructed and the instructions necessary for that class. Additionally, or alternatively instructions data may be used to notify an instructor of the type of class that is being instructed and the difficulty. Instructions data may further be retrieved from a database.

With continued reference to FIG. 1, additionally, fitness content 144 or secondary fitness content disclosed herein may be consistent with primary class content data and secondary class content data described in U.S. patent application Ser. No. 18/369,023, filed on Sep. 15, 2023, and titled “FITNESS CLASSROOM ASSEMBLY AND A METHOD OF USE,” having an attorney docket number of 1455-001USU1, the entirety of which is hereby incorporated by reference.

With continued reference to FIG. 1, processor 104 is configured to generate fitness content 144 using a content machine-learning model 160 of a machine-learning module 156 as a function of class data 132 and user data 112. In some embodiments, processor 104 may use a machine-learning module 156 to implement one or more algorithms or generate one or more machine-learning models, and calculate data as described herein. However, the machine-learning module 156 is exemplary and may not be necessary to generate one or more machine-learning models and perform any machine-learning described herein. In one or more embodiments, one or more machine-learning models may be generated using training data. Training data may include inputs and corresponding predetermined outputs so that a machine-learning model may use correlations between the provided exemplary inputs and outputs to develop an algorithm and/or relationship that then allows machine-learning model to determine its own outputs for inputs. Training data may contain correlations that a machine-learning process may use to model relationships between two or more categories of data elements. In other embodiments, a machine-learning module 156 may obtain a training set by querying a communicatively connected fitness database 124 that includes past inputs and outputs. Training data may include inputs from various types of databases, resources, and/or user inputs and outputs correlated to each of those inputs so that a machine-learning model may determine an output. Correlations may indicate causative and/or predictive links between data, which may be modeled as relationships, such as mathematical relationships, by machine-learning models, as described in further detail below. In one or more embodiments, training data may be formatted and/or organized by categories of data elements by, for example, associating data elements with one or more descriptors corresponding to categories of data elements. As a non-limiting example, training data may include data entered in standardized forms by persons or processes, such that entry of a given data element in a given field in a form may be mapped to one or more descriptors of categories. Elements in training data may be linked to descriptors of categories by tags, tokens, or other data elements. Machine-learning module 156 may be used to generate machine-learning models using training data. Machine-learning models may be trained by correlated inputs and outputs of training data. Training data may be data sets that have already been converted from raw data whether manually, by machine, or any other method. Training data may be stored in fitness database 124. Training data may also be retrieved from fitness database 124.

With continued reference to FIG. 1, machine-learning module 156 includes a content machine-learning model 160. Processor 104 is configured to generate content training data 164. Content training data 164 may include correlations between exemplary user data, exemplary class data and exemplary fitness contents. In some embodiments, content training data 164 may be stored in fitness database 124. In some embodiments, content training data 164 may be received from one or more users, fitness database 124, external computing devices, and/or previous iterations of processing. As a non-limiting example, content training data 164 may include instructions from a user, who may be an expert user, a past user in embodiments disclosed herein, or the like, which may be stored in memory and/or stored in fitness database 124, where the instructions may include labeling of training examples. In some embodiments, content training data 164 may be updated iteratively using a feedback loop. As a non-limiting example, processor 104 may update content training data 164 iteratively through a feedback loop as a function of user data 112, user prompt 116, class data 132, output of content machine-learning model 160, or the like. In some embodiments, processor 104 may be configured to generate content machine-learning model 160. Processor 104 is configured to train a content machine-learning model 160. In some embodiments, processor 104 may iteratively train content machine-learning model 160 using a feedback loop. As a non-limiting example, processor 104 may iteratively train content machine-learning model 160 as a function of difficultydifficultydifficultydifficulty . . . , output of content machine-learning model 160, another machine-learning models, or the like. In a non-limiting example, generating content machine-learning model 160 may include training, retraining, or fine-tuning content machine-learning model 160 using content training data 164 or updated content training data 164. Processor 104 is configured to generate fitness content 144 using content machine-learning model 160 (e.g., trained or updated content machine-learning model 160). In some embodiments, generating training data and training machine-learning models may be simultaneous.

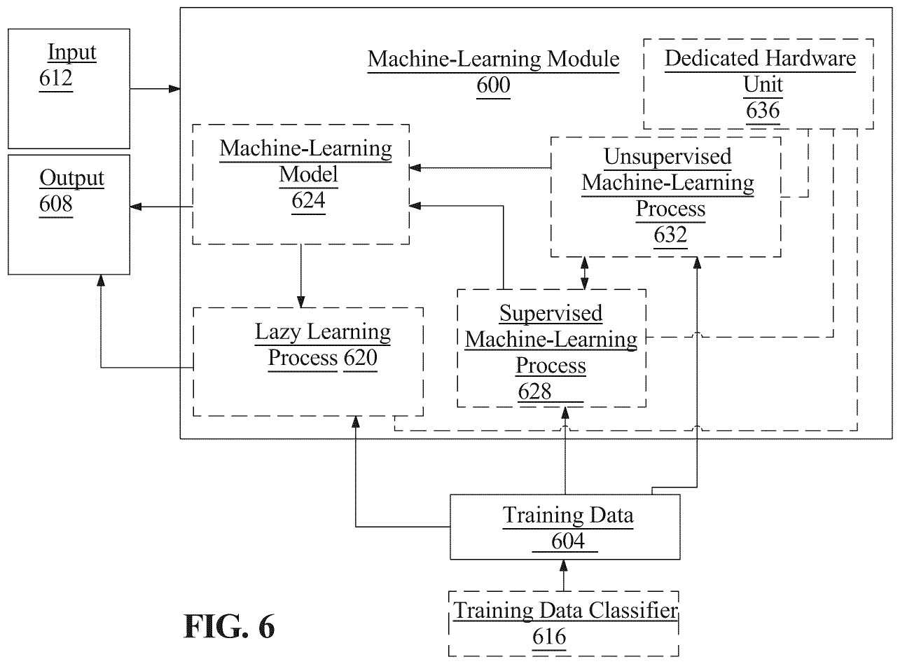

With continued reference to FIG. 1, in some embodiments, user or user data 112 may be classified to a user cohort using a cohort classifier. Cohort classifier may be consistent with any classifier discussed in this disclosure. Cohort classifier may be trained on cohort training data, wherein the cohort training data may include exemplary user data correlated to exemplary user cohorts. In some embodiments, a user or user data 112 may be classified to a user cohort and processor 104 may generate fitness content 144 based on the user cohort using a machine-learning module 156 as described in detail with respect to FIG. 6 and the resulting output may be used to update content training data 164. In some embodiments, instructor or instructor data 140 may be classified to a class cohort using a cohort classifier. Cohort classifier may be trained on cohort training data, wherein the cohort training data may include exemplary class data correlated to exemplary class cohorts. In some embodiments, class data 132 may be classified to a class cohort and processor 104 may generate fitness content 144 based on the class cohort using a machine-learning module 156.

With continued reference to FIG. 1, in one or more embodiments, processor 104 may implement one or more aspects of “generative artificial intelligence (AI),” a type of AI that uses machine-learning algorithms to create, establish, or otherwise generate data such as, without limitation, fitness content 144, and/or the like in any data structure as described herein (e.g., text, image, video, audio, among others) that is similar to one or more provided training examples. In an embodiment, machine-learning module 156 described herein may generate one or more generative machine-learning models that are trained on one or more set of content training data 164. One or more generative machine-learning models may be configured to generate new examples that are similar to the training data of the one or more generative machine-learning models but are not exact replicas; for instance, and without limitation, data quality or attributes of the generated examples may bear a resemblance to the training data provided to one or more generative machine-learning models, wherein the resemblance may pertain to underlying patterns, features, or structures found within the provided training data.

With continued reference to FIG. 1, in some cases, generative machine-learning models may include one or more generative models. As described herein, “generative models” refers to statistical models of the joint probability distribution P(X, Y) on a given observable variable x, representing features or data that can be directly measured or observed (e.g., user data 112, class data 132, and the like) and target variable y, representing the outcomes or labels that one or more generative models aims to predict or generate (e.g., fitness content 144). In some cases, generative models may rely on Bayes theorem to find joint probability; for instance, and without limitation, Naïve Bayes classifiers may be employed by processor 104 to categorize input data such as, without limitation, user data 112, class data 132, and the like into different user ability 168, movement error 172, user cohort, class cohort, or the like. The user ability 168 and movement error 172 disclosed herein are further described below.

In a non-limiting example, and with continued reference to FIG. 1, one or more generative machine-learning models may include one or more Naïve Bayes classifiers generated by processor 104, using a Naïve bayes classification algorithm. Naïve Bayes classification algorithm generates classifiers by assigning class labels to problem instances, represented as vectors of element values. Class labels are drawn from a finite set. Naïve Bayes classification algorithm may include generating a family of algorithms that assume that the value of a particular element is independent of the value of any other element, given a class variable. Naïve Bayes classification algorithm may be based on Bayes Theorem expressed as P(A/B)=P(B/A) P(A)=P(B), where P(A/B) is the probability of hypothesis A given data B also known as posterior probability; P(B/A) is the probability of data B given that the hypothesis A was true; P(A) is the probability of hypothesis A being true regardless of data also known as prior probability of A; and P(B) is the probability of the data regardless of the hypothesis. A naïve Bayes algorithm may be generated by first transforming training data into a frequency table. Processor 104 may then calculate a likelihood table by calculating probabilities of different data entries and classification labels. Processor 104 may utilize a naïve Bayes equation to calculate a posterior probability for each class. A class containing the highest posterior probability is the outcome of prediction.

Still referring to FIG. 1, although Naïve Bayes classifier may be primarily known as a probabilistic classification algorithm; however, it may also be considered a generative model described herein due to its capability of modeling the joint probability distribution P(X, Y) over observable variables X and target variable Y. In an embodiment, Naïve Bayes classifier may be configured to make an assumption that the features X are conditionally independent given class label Y, allowing generative model to estimate the joint distribution as P(X, Y)=P(Y)ΠiP(Xi|Y), wherein P(Y) may be the prior probability of the class, and P(Xᵢ|Y) is the conditional probability of each feature given the class. One or more generative machine-learning models containing Naïve Bayes classifiers may be trained on labeled training data, estimating conditional probabilities P(Xᵢ|Y) and prior probabilities P(Y) for each class; for instance, and without limitation, using techniques such as Maximum Likelihood Estimation (MLE). One or more generative machine-learning models containing Naïve Bayes classifiers may select a class label y according to prior distribution P(Y), and for each feature Xᵢ, sample at least a value according to conditional distribution P(Xᵢ|y). Sampled feature values may then be combined to form one or more new data instance with selected class label y. In a non-limiting example, one or more generative machine-learning models may include one or more Naïve Bayes classifiers to generate new examples of fitness content 144 based on user ability 168, movement error 172, user cohort, class cohort, or the like (e.g., beginner, intermediate, advanced of user ability 168), wherein the models may be trained using training data containing a plurality of features e.g., features of user data 112 and class data 132, and/or the like as input correlated to a plurality of labeled classes e.g., user ability 168, movement error 172, user cohort, class cohort, or the like, as output.

With continued reference to FIG. 1, in some cases, one or more generative machine-learning models may include generative adversarial network (GAN). As used in this disclosure, a “generative adversarial network” is a type of artificial neural network with at least two sub models (e.g., neural networks), a generator, and a discriminator, that compete against each other in a process that ultimately results in the generator learning to generate new data samples, wherein the “generator” is a component of the GAN that learns to create hypothetical data by incorporating feedbacks from the “discriminator” configured to distinguish real data from the hypothetical data. In some cases, generator may learn to make discriminator classify its output as real. In an embodiment, discriminator may include a supervised machine-learning model while generator may include an unsupervised machine-learning model as described in further detail with reference to FIG. 6.

With continued reference to FIG. 1, in an embodiment, discriminator may include one or more discriminative models, i.e., models of conditional probability P(Y|X=x) of target variable Y, given observed variable X. In an embodiment, discriminative models may learn boundaries between classes or labels in given training data. In a non-limiting example, discriminator may include one or more classifiers as described in further detail below with reference to FIG. 6 to distinguish between different categories e.g., correct vs. incorrect, or similar pair of contradictory terms, or states e.g., TRUE vs. FALSE within the context of generated data such as, without limitations, fitness content 144, and/or the like. In some cases, processor 104 may implement one or more classification algorithms such as, without limitation, Support Vector Machines (SVM), Logistic Regression, Decision Trees, and/or the like to define decision boundaries.

In a non-limiting example, and with continued reference to FIG. 1, generator of GAN may be responsible for creating synthetic data that resembles real fitness content 144. In some cases, GAN may be configured to receive user data 112 and class data 132 such as, without limitation, user information, user prompt 116, or the like, as input and generates corresponding fitness content 144 containing information describing or evaluating the performance of one or more users. On the other hand, discriminator of GAN may evaluate the authenticity of the generated content by comparing it to real fitness content 144, for example, discriminator may distinguish between genuine and generated content and providing feedback to generator to improve the model performance.

With continued reference to FIG. 1, in other embodiments, one or more generative models may also include a variational autoencoder (VAE). As used in this disclosure, a “variational autoencoder” is an autoencoder (i.e., an artificial neural network architecture) whose encoding distribution is regularized during the model training process in order to ensure that its latent space includes desired properties allowing new data sample generation. In an embodiment, VAE may include a prior and noise distribution respectively, trained using expectation-maximization meta-algorithms such as, without limitation, probabilistic PCA, sparse coding, among others. In a non-limiting example, VEA may use a neural network as an amortized approach to jointly optimize across input data and output a plurality of parameters for corresponding variational distribution as it maps from a known input space to a low-dimensional latent space. Additionally, or alternatively, VAE may include a second neural network, for example, and without limitation, a decoder, wherein the “decoder” is configured to map from the latent space to the input space.

In a non-limiting example, and with continued reference to FIG. 1, VAE may be used by processor 104 to model complex relationships between user data 112 and class data 132 e.g., user information, class information 136, user prompt 116, instructor data 140, or the like. In some cases, VAE may encode input data into a latent space, capturing a sequence of content fragment 148, content duration 176, or the like. Such encoding process may include learning one or more probabilistic mappings from observed user data 112 and class data 132 to a lower-dimensional latent representation. Latent representation may then be decoded back into the original data space, therefore reconstructing the user data 112 and class data 132. In some cases, such decoding process may allow VAE to generate new examples or variations that are consistent with the learned distributions.

With continued reference to FIG. 1, in some embodiments, one or more generative machine-learning models may be trained on a plurality of user movement data 128 as described herein, wherein the plurality of user movement data 128 may provide visual/acoustical information that generative machine-learning models analyze to understand the dynamics of images or videos of a user doing a specific pose in yoga. In other embodiments, training data may also include voice-over videos that include instruction how to do yoga. In some cases, such data may help generative machine-learning models to learn appropriate language and tone for providing videos that include instruction how to do yoga. Additionally, or alternatively, one or more generative machine-learning models may utilize one or more predefined templates representing, for example, and without limitation, correct fitness content 144. In a non-limiting example, one or more predefined movement images 180 (i.e., predefined models or representations of correct and ideal fitness content 144) may serve as benchmarks for comparing and evaluating plurality of user data 112 and class data 132.

With continued reference to FIG. 1, processor 104 may configure generative machine-learning models to analyze input data such as, without limitation, user prompt 116 to one or more predefined templates such as redefined predefined movement images 180 representing correct fitness content 144 described above, thereby allowing processor 104 to identify discrepancies or deviations from fitness content 144. In some cases, processor 104 may be configured to pinpoint specific errors in user movement data 128 or any other aspects of the user data 112. In a non-limiting example, processor 104 may be configured to implement generative machine-learning models to incorporate additional models to detect movement error 172. In some cases, errors may be classified into different categories or severity levels. In a non-limiting example, some errors may be considered minor, and generative machine-learning model such as, without limitation, GAN may be configured to generate fitness content 144 contain only slight adjustments while others may be more significant and demand more substantial corrections. In some embodiments, processor 104 may be configured to flag or highlight movement error 172, altering the user's movement (e.g., pose, motion, or the like) to user movement data 128, directly on the user data 112 and class data 132 using one or more generative machine-learning models described herein. In some cases, one or more generative machine-learning models may be configured to generate and output indicators such as, without limitation, visual indicator, audio indicator, and/or any other indicators as described above. Such indicators may be used to signal the detected error described herein.

With continued reference to FIG. 1, in some cases, processor 104 may be configured to identify and rank detected common deficiencies (e.g., movement error 172) across plurality of user movement data 128; for instance, and without limitation, one or more machine-learning models may classify errors in a specific order in a descending order of commonality difficulty. Such ranking process may enable a prioritization of most prevalent issues, allowing instructors or processor 104 to address the movement error 172. In a non-limiting example, if 80% of participants are struggling with a specific alignment in a particular pose, that issue may be detected and targeted with corrective instructions or demonstrations (e.g., movement modifier 184 of fitness content 144) generated by one or more generative machine-learning models.

With continued reference to FIG. 1, in some cases, one or more generative machine-learning models may also be applied by processor 104 to edit, modify, or otherwise manipulate existing data or data structures. In an embodiment, output of training data used to train one or more generative machine-learning models such as GAN as described herein may include content training data 164 that linguistically or visually demonstrate modified user movement data 128 (e.g., movement modifier 184 of fitness content 144). In some cases, fitness content 144 may be synchronized with user data 112 and class data 132, for example, and without limitation, in a side-by-side or even overlayed arrangement with the user movement data 128, providing real-time visual guidance. Additionally, or alternatively, fitness content 144, secondary fitness content or content parameter 152 may be generated using generative machine-learning models to address movement error 172. In some cases, such fitness content 144 may be integrated with user data 112 and class data 132, offering user a multisensory instructional experience.

Additionally, or alternatively, and with continued reference to FIG. 1, processor 104 may be configured to continuously monitor user data 112 and class data 132. In an embodiment, processor 104 may configure discriminator to provide ongoing feedback and further corrections as needed to subsequent input data (e.g., user movement data 128). In some cases, one or more sensors such as, without limitation, wearable device, motion sensor, or other sensors or devices described herein may provide user movement data 128 that may be used as subsequent input data or training data for one or more generative machine-learning models described herein. An iterative feedback loop may be created as processor 104 continuously receive real-time data, identify errors as a function of real-time data, delivering corrections based on the identified errors, and monitoring user movement data 128 on the delivered corrections. In an embodiment, processor 104 may be configured to retrain one or more generative machine-learning models based on user movement data 128 or update training data of one or more generative machine-learning models by integrating user movement data 128 into the original training data. In such embodiment, iterative feedback loop may allow machine-learning module to adapt to the user prompt 116, enabling one or more generative machine-learning models described herein to learn and update based on user movement data 128 and generated feedback.

With continued reference to FIG. 1, other exemplary embodiments of generative machine-learning models may include, without limitation, long short-term memory networks (LSTMs), (generative pre-trained) transformer (GPT) models, mixture density networks (MDN), and/or the like. As an ordinary person skilled in the art, upon reviewing the entirety of this disclosure, will be aware of various generative machine-learning models may be used to generate fitness content 144.

With continued reference to FIG. 1, in a further non-limiting embodiment, machine-learning module may be further configured to generate a multi-model neural network that combines various neural network architectures described herein. In a non-limiting example, multi-model neural network may combine LSTM for time-series analysis with GPT models for natural language processing. Such fusion may be applied by processor 104 to generate fitness content 144. In some cases, multi-model neural network may also include a hierarchical multi-model neural network, wherein the hierarchical multi-model neural network may involve a plurality of layers of integration; for instance, and without limitation, different models may be combined at various stages of the network. Convolutional neural network (CNN) may be used for image feature extraction, followed by LSTMs for sequential pattern recognition, and a MDN at the end for probabilistic modeling. Other exemplary embodiments of multi-model neural network may include, without limitation, ensemble-based multi-model neural network, cross-modal fusion, adaptive multi-model network, among others. As an ordinary person skilled in the art, upon reviewing the entirety of this disclosure, will be aware of various generative machine-learning models may be used to generate fitness content 144 described herein. As an ordinary person skilled in the art, upon reviewing the entirety of this disclosure, will be aware of various multi-model neural network and combination thereof that may be implemented by apparatus 100 in consistent with this disclosure.

With continued reference to FIG. 1, machine-learning module 156 may include a large language model (LLM). A “large language model,” as used herein, is a deep learning data structure that can recognize, summarize, translate, predict and/or generate text and other content based on knowledge gained from massive datasets. Large language models may be trained on large sets of data. Training sets may be drawn from diverse sets of data such as, as non-limiting examples, video streaming platform, website, and the like. In some embodiments, training sets may include a variety of subject matters, such as, as nonlimiting examples, exemplary user data, exemplary class data, exemplary fitness contents, and the like. In some embodiments, training sets of an LLM may include information from one or more public or private databases (e.g., fitness database 124). As a non-limiting example, training sets may include databases associated with a user. In an embodiment, an LLM may include one or more architectures based on capability requirements of an LLM. Exemplary architectures may include, without limitation, GPT (Generative Pretrained Transformer), BERT (Bidirectional Encoder Representations from Transformers), T5 (Text-To-Text Transfer Transformer), and the like. Architecture choice may depend on a needed capability such generative, contextual, or other specific capabilities.

With continued reference to FIG. 1, in some embodiments, an LLM may be generally trained. As used in this disclosure, a “generally trained” LLM is an LLM that is trained on a general training set comprising a variety of subject matters, data sets, and fields. In some embodiments, an LLM may be initially generally trained. Additionally, or alternatively, an LLM may be specifically trained. As used in this disclosure, a “specifically trained” LLM is an LLM that is trained on a specific training set, wherein the specific training set includes data including specific correlations for the LLM to learn. As a non-limiting example, an LLM may be generally trained on a general training set, then specifically trained on a specific training set. In an embodiment, specific training of an LLM may be performed using a supervised machine-learning process. In some embodiments, generally training an LLM may be performed using an unsupervised machine-learning process. As a non-limiting example, specific training set may include information from a database. As a non-limiting example, specific training set may include text related to the users such as user information, user prompt 116, or the like correlated to examples of fitness contents 144. In an embodiment, training one or more machine-learning models may include setting the parameters of the one or more models (weights and biases) either randomly or using a pretrained model. Generally training one or more machine-learning models on a large corpus of text data can provide a starting point for fine-tuning on a specific task. A model such as an LLM may learn by adjusting its parameters during the training process to minimize a defined loss function, which measures the difference between predicted outputs and ground truth. Once a model has been generally trained, the model may then be specifically trained to fine-tune the pretrained model on task-specific data to adapt it to the target task. Fine-tuning may involve training a model with task-specific training data, adjusting the model's weights to optimize performance for the particular task. In some cases, this may include optimizing the model's performance by fine-tuning hyperparameters such as learning rate, batch size, and regularization. Hyperparameter tuning may help in achieving the best performance and convergence during training. In an embodiment, fine-tuning a pretrained model such as an LLM may include fine-tuning the pretrained model using Low-Rank Adaptation (LoRA). As used in this disclosure, “Low-Rank Adaptation” is a training technique for large language models that modifies a subset of parameters in the model. Low-Rank Adaptation may be configured to make the training process more computationally efficient by avoiding a need to train an entire model from scratch. In an exemplary embodiment, a subset of parameters that are updated may include parameters that are associated with a specific task or domain.

With continued reference to FIG. 1, in some embodiments an LLM may include and/or be produced using Generative Pretrained Transformer (GPT), GPT-2, GPT-3, GPT-4, and the like. GPT, GPT-2, GPT-3, GPT-3.5, and GPT-4 are products of Open AI Inc., of San Francisco, CA. An LLM may include a text prediction based algorithm configured to receive user prompt 116 and apply a probability distribution to the words already typed in a sentence to work out the most likely word to come next in augmented articles. For example, if some words that have already been typed are “the next position is a Downward,” then it may be highly likely that the word “Dog” will come next. An LLM may output such predictions by ranking words by likelihood or a prompt parameter. For the example given above, an LLM may score “Dog” as the most likely, “Facing Dog” as the next most likely, and the like. An LLM may include an encoder component and a decoder component.

With continued reference to FIG. 1, an LLM may include a transformer architecture. In some embodiments, encoder component of an LLM may include transformer architecture. A “transformer architecture,” for the purposes of this disclosure is a neural network architecture that uses self-attention and positional encoding. Transformer architecture may be designed to process sequential input data, such as natural language, with applications towards tasks such as translation and text summarization. Transformer architecture may process the entire input all at once. “Positional encoding,” for the purposes of this disclosure, refers to a data processing technique that encodes the location or position of an entity in a sequence. In some embodiments, each position in the sequence may be assigned a unique representation. In some embodiments, positional encoding may include mapping each position in the sequence to a position vector. In some embodiments, trigonometric functions, such as sine and cosine, may be used to determine the values in the position vector. In some embodiments, position vectors for a plurality of positions in a sequence may be assembled into a position matrix, wherein each row of position matrix may represent a position in the sequence.

With continued reference to FIG. 1, an LLM and/or transformer architecture may include an attention mechanism. An “attention mechanism,” as used herein, is a part of a neural architecture that enables a system to dynamically quantify the relevant features of the input data. In the case of natural language processing, input data may be a sequence of textual elements. It may be applied directly to the raw input or to its higher-level representation.

With continued reference to FIG. 1, attention mechanism may represent an improvement over a limitation of an encoder-decoder model. An encoder-decider model encodes an input sequence to one fixed length vector from which the output is decoded at each time step. This issue may be seen as a problem when decoding long sequences because it may make it difficult for the neural network to cope with long sentences, such as those that are longer than the sentences in the training corpus. Applying an attention mechanism, an LLM may predict the next word by searching for a set of positions in a source sentence where the most relevant information is concentrated. An LLM may then predict the next word based on context vectors associated with these source positions and all the previously generated target words, such as textual data of a dictionary correlated to a prompt in a training data set. A “context vector,” as used herein, are fixed-length vector representations useful for document retrieval and word sense disambiguation.

With continued reference to FIG. 1, attention mechanism may include, without limitation, generalized attention self-attention, multi-head attention, additive attention, global attention, and the like. In generalized attention, when a sequence of words or an image is fed to an LLM, it may verify each element of the input sequence and compare it against the output sequence. Each iteration may involve the mechanism's encoder capturing the input sequence and comparing it with each element of the decoder's sequence. From the comparison scores, the mechanism may then select the words or parts of the image that it needs to pay attention to. In self-attention, an LLM may pick up particular parts at different positions in the input sequence and over time compute an initial composition of the output sequence. In multi-head attention, an LLM may include a transformer model of an attention mechanism. Attention mechanisms, as described above, may provide context for any position in the input sequence. For example, if the input data is a natural language sentence, the transformer does not have to process one word at a time. In multi-head attention, computations by an LLM may be repeated over several iterations, each computation may form parallel layers known as attention heads. Each separate head may independently pass the input sequence and corresponding output sequence element through a separate head. A final attention score may be produced by combining attention scores at each head so that every nuance of the input sequence is taken into consideration. In additive attention (Bahdanau attention mechanism), an LLM may make use of attention alignment scores based on a number of factors. Alignment scores may be calculated at different points in a neural network, and/or at different stages represented by discrete neural networks. Source or input sequence words are correlated with target or output sequence words but not to an exact degree. This correlation may take into account all hidden states and the final alignment score is the summation of the matrix of alignment scores. In global attention (Luong mechanism), in situations where neural machine translations are required, an LLM may either attend to all source words or predict the target sentence, thereby attending to a smaller subset of words.

With continued reference to FIG. 1, multi-headed attention in encoder may apply a specific attention mechanism called self-attention. Self-attention allows models such as an LLM or components thereof to associate each word in the input, to other words. As a non-limiting example, an LLM may learn to associate the word “you,” with “how” and “are”. It's also possible that an LLM learns that words structured in this pattern are typically a question and to respond appropriately. In some embodiments, to achieve self-attention, input may be fed into three distinct fully connected neural network layers to create query, key, and value vectors. Query, key, and value vectors may be fed through a linear layer; then, the query and key vectors may be multiplied using dot product matrix multiplication in order to produce a score matrix. The score matrix may determine the amount of focus for a word should be put on other words (thus, each word may be a score that corresponds to other words in the time-step). The values in score matrix may be scaled down. As a non-limiting example, score matrix may be divided by the square root of the dimension of the query and key vectors. In some embodiments, the softmax of the scaled scores in score matrix may be taken. The output of this softmax function may be called the attention weights. Attention weights may be multiplied by your value vector to obtain an output vector. The output vector may then be fed through a final linear layer.

Still referencing FIG. 1, in order to use self-attention in a multi-headed attention computation, query, key, and value may be split into N vectors before applying self-attention. Each self-attention process may be called a “head.” Each head may produce an output vector and each output vector from each head may be concatenated into a single vector. This single vector may then be fed through the final linear layer discussed above. In theory, each head can learn something different from the input, therefore giving the encoder model more representation power.

With continued reference to FIG. 1, encoder of transformer may include a residual connection. Residual connection may include adding the output from multi-headed attention to the positional input embedding. In some embodiments, the output from residual connection may go through a layer normalization. In some embodiments, the normalized residual output may be projected through a pointwise feed-forward network for further processing. The pointwise feed-forward network may include a couple of linear layers with a ReLU activation in between. The output may then be added to the input of the pointwise feed-forward network and further normalized.

Continuing to refer to FIG. 1, transformer architecture may include a decoder. Decoder may a multi-headed attention layer, a pointwise feed-forward layer, one or more residual connections, and layer normalization (particularly after each sub-layer), as discussed in more detail above. In some embodiments, decoder may include two multi-headed attention layers. In some embodiments, decoder may be autoregressive. For the purposes of this disclosure, “autoregressive” means that the decoder takes in a list of previous outputs as inputs along with encoder outputs containing attention information from the input.

With further reference to FIG. 1, in some embodiments, input to decoder may go through an embedding layer and positional encoding layer in order to obtain positional embeddings. Decoder may include a first multi-headed attention layer, wherein the first multi-headed attention layer may receive positional embeddings.

With continued reference to FIG. 1, first multi-headed attention layer may be configured to not condition to future tokens. As a non-limiting example, when computing attention scores on the word “am,” decoder should not have access to the word “fine” in “I am fine,” because that word is a future word that was generated after. The word “am” should only have access to itself and the words before it. In some embodiments, this may be accomplished by implementing a look-ahead mask. Look ahead mask is a matrix of the same dimensions as the scaled attention score matrix that is filled with “0s” and negative infinities. For example, the top right triangle portion of look-ahead mask may be filled with negative infinities. Look-ahead mask may be added to scaled attention score matrix to obtain a masked score matrix. Masked score matrix may include scaled attention scores in the lower-left triangle of the matrix and negative infinities in the upper-right triangle of the matrix. Then, when the softmax of this matrix is taken, the negative infinities will be zeroed out; this leaves zero attention scores for “future tokens.”

With continued reference to FIG. 1, second multi-headed attention layer may use encoder outputs as queries and keys and the outputs from the first multi-headed attention layer as values. This process matches the encoder's input to the decoder's input, allowing the decoder to decide which encoder input is relevant to put a focus on. The output from second multi-headed attention layer may be fed through a pointwise feedforward layer for further processing.

With continued reference to FIG. 1, the output of the pointwise feedforward layer may be fed through a final linear layer. This final linear layer may act as a classifier. This classifier may be as big as the number of classes that you have. For example, if you have 10,000 classes for 10,000 words, the output of that classifier will be of size 10,000. The output of this classifier may be fed into a softmax layer which may serve to produce probability scores between zero and one. The index may be taken of the highest probability score in order to determine a predicted word.

With continued reference to FIG. 1, decoder may take this output and add it to the decoder inputs. Decoder may continue decoding until a token is predicted. Decoder may stop decoding once it predicts an end token.

Continuing to refer to FIG. 1, in some embodiment, decoder may be stacked N layers high, with each layer taking in inputs from the encoder and layers before it. Stacking layers may allow an LLM to learn to extract and focus on different combinations of attention from its attention heads.

With continued reference to FIG. 1, an LLM may receive an input. Input may include a string of one or more characters. Inputs may additionally include unstructured data. For example, input may include one or more words, a sentence, a paragraph, a thought, a query, and the like. A “query” for the purposes of the disclosure is a string of characters that poses a question. In some embodiments, input may be received from a user device. User device may be any computing device that is used by a user. As non-limiting examples, user device may include desktops, laptops, smartphones, tablets, and the like. In some embodiments, input may include any set of data associated with user data 112, user prompt 116, class data 132, fitness content 144, or the like.

With continued reference to FIG. 1, an LLM may generate at least one annotation as an output. At least one annotation may be any annotation as described herein. In some embodiments, an LLM may include multiple sets of transformer architecture as described above. Output may include a textual output. A “textual output,” for the purposes of this disclosure is an output comprising a string of one or more characters. Textual output may include, for example, a plurality of annotations for unstructured data. In some embodiments, textual output may include a phrase or sentence identifying the status of a user query. In some embodiments, textual output may include a sentence or plurality of sentences describing a response to a user query. As a non-limiting example, this may include restrictions, timing, advice, dangers, benefits, and the like.

With continued reference to FIG. 1, memory 108 contains instructions configuring processor 104 to adjust at least a content parameter 152 of fitness content 144. Fitness content 144 includes content parameter 152. For the purposes of this disclosure, a “content parameter” is the characteristic of a fitness content. As a non-limiting example, content parameter 152 may include resolution, frame rate, aspect ratio, audio setting, content duration 176, sequence of content fragments 148, or the like. For the purposes of this disclosure, a “content fragment” is a segment of a fitness content that has one specific theme. As a non-limiting example, content fragment 148 may include short video fragment of entire fitness class video, one sentence or paragraph of text description, one section of fitness class audio recording, or the like. For example, and without limitation, fitness content 144 may include a plurality of content fragments 148 (e.g., short videos) that talks about different positions of yoga from a yoga fitness class video (e.g., fitness content 144). Continuing the non-limiting example, each content fragment 148 may include instructions related to one position. Persons skilled in the art, upon reviewing the entirety of this disclosure, may appreciate various content fragments 148 there can be. For the purposes of this disclosure, “content duration” is the length of time it takes for the entire fitness content to be from strat to finish. For example, and without limitation, for a yoga class video, content duration 176 may be 30 minutes. In some embodiments, content parameter 152 may be stored in fitness database 124. In some embodiments, processor 104 may retrieve content parameter 152 from fitness database 124 or user or instructor may manually input content parameter 152.

With continued reference to FIG. 1, processor 104 is configured to adjust content parameter 152 of fitness content 144 as a function of user prompt 116. As a non-limiting example, if user prompt 116 includes “could you please let me hold the Down Dog for a while longer?,” then processor 104 may adjust content duration 176 of content fragment 148 related to the Down Dog position to be longer. As another non-limiting example, if user prompt 116 includes “is it possible to put a Warrior pose in the sequence today as well as crow balancing?,” then processor 104 may adjust a sequence of content fragments 148 of fitness content 144 to include the Warrior pose and crow balancing in fitness content 144. The examples disclosed herein are merely examples and persons skilled in the art, upon reviewing the entirety of this disclosure, may appreciate various adjustments that can be made to content parameter 152 of fitness content 144. In some embodiments, adjustment of fitness content 144 may include adding or removing content fragment 148 in fitness content 144, replacing one content fragment 148 to other content fragment 148 that is shorter or longer, compressing fitness content 144 to be faster or lengthening fitness content to be slower, adding or removing secondary fitness content, or the like.

With continued reference to FIG. 1, processor may apply data compression techniques to fitness content 144 to adjust content parameter 152. “Data compression,” as used in this disclosure, is the process of encoding information using fewer bits than the original representation. Any particular compression is either lossy or lossless. Lossless compression reduces bits by identifying and eliminating statistical redundancy. No information is lost in lossless compression. Lossy compression reduces bits by removing unnecessary or less important information. In some embodiments, processor may utilize an encoder to perform data compression on fitness content 144. Fitness content 144 may be compressed in order to optimize speed and/or cost of transmission of fitness content 144. For fitness content 144 including video, a processor may be configured to identify a series of frames (e.g., content fragments 148) of a video. The series of frames may include a group of pictures having some degree of internal similarity, such as a group of pictures representing a scene. In some embodiments, comparing series of frames may include video compression by inter-frame coding. The “inter” part of the term refers to the use of inter frame prediction. This kind of prediction tries to take advantage from temporal redundancy between neighboring frames enabling higher compression rates. Video data compression is the process of encoding information using fewer bits than the original representation. Data compression may be subject to a space-time complexity trade-off. For instance, a compression scheme for video may require expensive hardware for the video to be decompressed fast enough to be viewed as it is being decompressed, and the option to decompress the video in full before watching it may be inconvenient or require additional storage. Video data may be represented as a series of still image frames. Such data usually contains abundant amounts of spatial and temporal redundancy. Video compression algorithms attempt to reduce redundancy and store information more compactly.

With continued reference to FIG. 1, inter-frame coding may function by comparing each frame in the video with another frame, which may include a previous frame. Individual frames of a video sequence may be compared between frames, and a video compression codec may send only the differences from a reference frame for frames other than the reference frame. If a frame contains areas where nothing has moved, a system may issue a short command that copies that part of a reference frame into the instant frame. If sections of a frame move in a manner describable through vector mathematics and/or affine transformations, or differences in color, brightness, tone, or the like, an encoder may emit a command that directs a decoder to shift, rotate, lighten, or darken a relevant portion. An encoder may also transmit a residual signal which describes remaining more subtle differences from reference frame, for instance by subtracting a predicted frame generated through vector motion commands from the reference frame pixel by pixel. Using entropy coding, these residual signals may have a more compact representation than a full signal. In areas of video with more motion, compression may encode more data to keep up with a larger number of pixels that are changing. As used in this disclosure, reference frames are frames of a compressed video (a complete picture) that are used to define future frames. As such, they are only used in inter-frame compression techniques. Some modern video encoding standards, such as H.264/AVC, allow the use of multiple reference frames. This may allow a video encoder to choose among more than one previously decoded frame on which to base each macroblock in another frame.

With continued reference to FIG. 1, two frame types used in inter-fame coding may include P-frames and B-frames. A P-frame (Predicted picture) may hold only changes in an image from a reference frame. For example, in a scene where a car moves across a stationary background, only the car's movements may need to be encoded; an encoder does not need to store the unchanging background pixels in the P-frame, thus saving space. A B-frame (Bidirectional predicted picture) may save even more space by using differences between a current frame and both preceding and following frames to specify its content. An inter coded frame may be divided into blocks known as macroblocks. A macroblock may include a processing unit in image and video compression formats based on linear block transforms, such as without limitation a discrete cosine transform (DCT). A macroblock may consist of 16×16 samples, for instance as measured in pixels, and may be further subdivided into transform blocks, and may be further subdivided into prediction blocks. Formats which are based on macroblocks may include JPEG, where they are called MCU blocks, H.261, MPEG-1 Part 2, H.262/MPEG-2 Part 2, H.263, MPEG-4 Part 2, and H.264/MPEG-4 AVC. After an inter coded frame is divided into macroblocks, instead of and/or in addition to directly encoding raw pixel values for each block, an encoder may identify a block similar to the one it is encoding on another frame, referred to as a reference frame. This process may be performed by a block matching algorithm. If an encoder succeeds in its search for a reference frame, a block may be encoded by a vector, known as motion vector, which points to a position of a matching block at the reference frame. A process of motion vector determination may be referred to as motion estimation. Residual values, based on differences between estimated blocks and blocks they are meant to estimate, may be referred to as a prediction error and may be transformed and sent to a decoder.

With continued reference to FIG. 1, using a motion vector pointing to a matched block and/or a prediction error, a decoder may reconstruct raw pixels of an encoded block without requiring transmission of the full set of pixels. For example, a video may be compressed using a P-frame algorithm and broken down into macroblocks. Individual still images taken from a video may then be compared against a reference frame taken from another a video or augmented video. A P-frame from a video may only hold the changes in image from target a video. For example, if both a video include a similar, then what may be encoded and stored may include subtle changes such as an additional character dialogue or character appearances compared to the video without the dialogue. Exemplary video compression codecs may include without limitation H.26x codecs, MPEG formats, VVC, SVT-AV1, and the like. In some cases, compression may be lossy, in which some information may be lost during compression.

Alternatively, or additionally, in some cases, compression may be substantially lossless, where substantially no information is lost during compression. In some cases, image component may include a plurality of temporally sequential frames. In some cases, each frame may be encoded (e.g., bitmap or vector-based encoding). In some embodiments, a classifier may receive an input from a processor including a video encoder. In a non-limiting example, a processor may select a reference frame to be encoded and may transmit the reference frame to a classifier; such a classifier may include a classifier configured to categorize images based on a pose being performed in an image, as described below. In some embodiments, categorizing reference frames using a classifier may allow for a video frame, or a section of a video represented by a frame, to be categorized. Each frame may be configured to be displayed by way of a display. Exemplary displays include without limitation light emitting diode (LED) displays, cathode ray tube (CRT) displays, liquid crystal displays (LCDs), organic LEDs (OLDs), quantum dot displays, projectors (e.g., scanned light projectors), and the like.

With continued reference to FIG. 1, in some embodiments, processor 104 may perform a plurality of digital processing techniques such as acquisition, image enhancement, image restoration, color image processing, data augmentation, wavelets and multi-resolution processing, image compression, morphological processing, representation and description, object and recognition, and the like. In some embodiments, processing fitness content 144 includes utilizing feature extraction. Feature extraction is a part of computer vision, in which an initial set of the raw data is divided and reduced to more manageable groups. “Features,” as used in this disclosure, are parts or patterns of an object in an image that help to identify it. For example—a square has 4 corners and 4 edges, they can be called features of the square. Features may include properties like corners, edges, regions of interest points, ridges, etc. In some embodiments, processing fitness content 144 may include segmenting an image of the fitness content 144 utilizing image segmentation. “Image segmentation,” as used in this disclosure, is a sub-domain of computer vision and digital image processing, as described further below, which aims at grouping similar regions or segments of an image under their respective class labels.

With continued reference to FIG. 1, processor 104 may use interpolation and/or upsampling methods to process fitness content 144. For instance, processor may convert a low pixel count image into a desired number of pixels. As a non-limiting example, a low pixel count image may have 100 pixels, however a desired number of pixels may be 128. Processor may interpolate the low pixel count image to convert the 100 pixels into 128 pixels. It should also be noted that one of ordinary skill in the art, upon reading this disclosure, would know the various methods to interpolate a low pixel count image to a desired number of pixels. In some instances, a set of interpolation rules may be trained by sets of highly detailed images and images that may have been downsampled to smaller numbers of pixels, and a neural network or other machine-learning model that is trained using the training sets of highly detailed images to predict interpolated pixel values in a facial picture context. As a non-limiting example, a sample picture with sample-expanded pixels (e.g., pixels added between the original pixels) may be input to a neural network or machine-learning model and output a pseudo replica sample-picture with dummy values assigned to pixels between the original pixels based on a set of interpolation rules. In some instances, a machine-learning model may have a set of interpolation rules trained by sets of highly detailed images and images that have been downsampled to smaller numbers of pixels, and a neural network or other machine-learning model that is trained using those examples to predict interpolated pixel values in a facial picture context. I.e., you run the picture with sample-expanded pixels (the ones added between the original pixels, with dummy values) through this neural network or model and it fills in values to replace the dummy values based on the rules.

With continued reference to FIG. 1, processor 104 may utilize sample expander methods, a low-pass filter, or both. As used in this disclosure, a “low-pass filter” is a filter that passes signals with a frequency lower than a selected cutoff frequency and attenuates signals with frequencies higher than the cutoff frequency. The exact frequency response of the filter depends on the filter design. In some embodiments, processor may use luma or chroma averaging to fill in pixels in between original image pixels. Processor may down-sample fitness content 144 to a desired lower number of pixels. As a non-limiting example, a high pixel count image may have 256 pixels, however a desired number of pixels may be 128. Processor may down-sample the high pixel count image to convert the 256 pixels into 128 pixels.

With continued reference to FIG. 1, in some embodiments, processor may be configured to perform downsampling on data such as without limitation fitness content 144. Downsampling, also known as decimation, may include removing every Nth entry in a sequence of samples, all but every Nth entry, or the like, which is a process known as “compression,” and may be performed, for instance by an N-sample compressor implemented using hardware or software. Anti-aliasing and/or anti-imaging filters, and/or low-pass filters, may be used to clean up side-effects of compression.

With continued reference to FIG. 1, processor 104 may classify fitness content 144 to a plurality of categories, such as poses or movements, using a machine-learning model in a machine-learning module 156 such as a classifier. A classifier may include a machine-learning model, such as a mathematical model, neural net, or program generated by a machine-learning algorithm known as a “classification algorithm,” that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. For example, a classifier may receive a plurality of fitness content 144 and output a datum that can be used to categorize the fitness content 144 into bins, such as categories, such as labels of poses or movements. Processor 104 may generate a classifier using a classification algorithm, which may include a process whereby a processor derives a classifier from training data. Training data may include images of individuals performing poses, tagged with the poses they are performing. In some embodiments, a classifier may be applied to frames from a video, in order to categorize that frame and/or a section of the video represented by that frame. In some embodiments, a classifier may receive an input from a processor including a video encoder, as described above. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers.

With continued reference to FIG. 1, classification may include particular image requirements. In some instances, image requirements may include resolution, pixel count, and the like. Classification may include, without limitation, matching fitness content 144 to one or more requirements. Image classifier may be trained, without limitation, using training data containing images of a type to be matched, such as images of; thus image classifier may be trained to detect whether an object class depicted in a given image matches an object class depicted in a stored image, or otherwise match a subject of an image to a subject of another image.

With continued reference to FIG. 1, in some embodiments, image pixel count may be modified based on the input requirements of a machine-learning model, such as an image classifier. For example, an image classifier may have a number of inputs into which pixels are input, and thus may require either increasing or decreasing the number of pixels in an image to be input and/or used for training image classifier. In some embodiments, interpolation, upsampling, sample expander, low pass filter, and/or downsampling may be used to modify pixel count to a required number of pixels for an image classifier.

With continued reference to FIG. 1, in some embodiments, processor 104 may analyze user prompt 116 and may adjust content parameter 152 of fitness content 144 as a function of the analysis. In some embodiments, processor 104 may analyze user prompt 116 using a language processing module. In some embodiments, processor 104 may use a language processing module to find a keyword. The language processing module may be configured to extract, from user prompt 116, one or more words. One or more words may include, without limitation, strings of one or more characters, including without limitation any sequence or sequences of letters, numbers, punctuation, diacritic marks, engineering symbols, geometric dimensioning and tolerancing (GD&T) symbols, chemical symbols and formulas, spaces, whitespace, and other symbols, including any symbols usable as textual data as described above. Textual data may be parsed into tokens, which may include a simple word (sequence of letters separated by whitespace) or more generally a sequence of characters as described previously. The term “token,” as used herein, refers to any smaller, individual groupings of text from a larger source of text; tokens may be broken up by word, pair of words, sentence, or other delimitation. These tokens may in turn be parsed in various ways. Textual data may be parsed into words or sequences of words, which may be considered words as well. Textual data may be parsed into “n-grams,” where all sequences of n consecutive characters are considered. Any or all possible sequences of tokens or words may be stored as “chains,” for example for use as a Markov chain or Hidden Markov Model.

With continued reference to FIG. 1, language processing module may operate to produce a language processing model. Language processing model may include a program automatically generated by processor 104 and/or language processing module to produce associations between one or more words extracted from at least a document and detect associations, including without limitation mathematical associations, between such words. Associations between language elements, where language elements include for purposes herein extracted words, relationships of such categories to other such term may include, without limitation, mathematical associations, including without limitation statistical correlations between any language element and any other language element and/or language elements. Statistical correlations and/or mathematical associations may include probabilistic formulas or relationships indicating, for instance, a likelihood that a given extracted word indicates a given category of semantic meaning. As a further example, statistical correlations and/or mathematical associations may include probabilistic formulas or relationships indicating a positive and/or negative association between at least an extracted word and/or a given semantic meaning; positive or negative indication may include an indication that a given document is or is not indicating a category semantic meaning. Whether a phrase, sentence, word, or other textual element in a document or corpus of documents constitutes a positive or negative indicator may be determined, in an embodiment, by mathematical associations between detected words, comparisons to phrases and/or words indicating positive and/or negative indicators that are stored in memory at computing device, or the like.

With continued reference to FIG. 1, language processing module may generate the language processing model by any suitable method, including without limitation a natural language processing classification algorithm; language processing model may include a natural language process classification model that enumerates and/or derives statistical relationships between input terms and output terms. Algorithm to generate language processing model may include a stochastic gradient descent algorithm, which may include a method that iteratively optimizes an objective function, such as an objective function representing a statistical estimation of relationships between terms, including relationships between input terms and output terms, in the form of a sum of relationships to be estimated. In an alternative or additional approach, sequential tokens may be modeled as chains, serving as the observations in a Hidden Markov Model (HMM). HMMs, as used herein, are statistical models with inference algorithms that that may be applied to the models. In such models, a hidden state to be estimated may include an association between an extracted words, phrases, and/or other semantic units. There may be a finite number of categories to which an extracted word may pertain; an HMM inference algorithm, such as the forward-backward algorithm or the Viterbi algorithm, may be used to estimate the most likely discrete state given a word or sequence of words. Language processing module may combine two or more approaches. For instance, and without limitation, machine-learning program may use a combination of Naive-Bayes (NB), Stochastic Gradient Descent (SGD), and parameter grid-searching classification techniques; the result may include a classification algorithm that returns ranked associations.

With continued reference to FIG. 1, generating language processing model may include generating a vector space, which may be a collection of vectors, defined as a set of mathematical objects that can be added together under an operation of addition following properties of associativity, commutativity, existence of an identity element, and existence of an inverse element for each vector, and can be multiplied by scalar values under an operation of scalar multiplication compatible with field multiplication, and that has an identity element is distributive with respect to vector addition, and is distributive with respect to field addition. Each vector in an n-dimensional vector space may be represented by an n-tuple of numerical values. Each unique extracted word and/or language element as described above may be represented by a vector of the vector space. In an embodiment, each unique extracted and/or other language element may be represented by a dimension of vector space; as a non-limiting example, each element of a vector may include a number representing an enumeration of co-occurrences of the word and/or language element represented by the vector with another word and/or language element. Vectors may be normalized, scaled according to relative frequencies of appearance and/or file sizes. In an embodiment associating language elements to one another as described above may include computing a degree of vector similarity between a vector representing each language element and a vector representing another language element; vector similarity may be measured according to any norm for proximity and/or similarity of two vectors, including without limitation cosine similarity, which measures the similarity of two vectors by evaluating the cosine of the angle between the vectors, which can be computed using a dot product of the two vectors divided by the lengths of the two vectors. Degree of similarity may include any other geometric measure of distance between vectors.

With continued reference to FIG. 1, language processing module may use a corpus of documents to generate associations between language elements in a language processing module, and processor 104 may then use such associations to analyze words extracted from one or more documents and determine that the one or more documents indicate significance of a category. In an embodiment, language module and/or processor 104 may perform this analysis using a selected set of significant documents, such as documents identified by one or more experts as representing good information; experts may identify or enter such documents via graphical user interface or may communicate identities of significant documents according to any other suitable method of electronic communication, or by providing such identity to other persons who may enter such identifications into processor 104. Documents may be entered into a computing device by being uploaded by an expert or other persons using, without limitation, file transfer protocol (FTP) or other suitable methods for transmission and/or upload of documents; alternatively or additionally, where a document is identified by a citation, a uniform resource identifier (URI), uniform resource locator (URL) or other datum permitting unambiguous identification of the document, processor 104 may automatically obtain the document using such an identifier, for instance by submitting a request to a database or compendium of documents such as JSTOR as provided by Ithaka Harbors, Inc. of New York.

With continued reference to FIG. 1, in some embodiments, processor 104 may analyze user prompt 116 using automatic speech recognition (ASR). As a non-limiting example, ASR may analyze audio (e.g., user prompt 116). For the purposes of this disclosure, “automatic speech recognition” is a technology that converts spoken language into written text or machine-readable form. In a non-limiting example, processor 104 may use audio to aid in recognition of user prompt 116 or keywords of user prompt 116. In some embodiments, ASR may include techniques employing language processing to aid speech recognition processes. In some cases, ASR may be used to decode (i.e., recognize) indeterministic phonemes or help in forming a preponderance among probabilistic candidates. In some cases, ASR may include an audio-based automatic speech recognition process and an image-based automatic speech recognition process. ASR may analysis audio according to any method described herein, for instance using a Mel frequency cepstral coefficients (MFCCs) and/or log-Mel spectrogram derived from raw audio samples. In some cases, feature recognition may include any feature recognition process described in this disclosure, for example a variant of a convolutional neural network. In some cases, ASR employs an audio datum to recognize user prompt 116. For instance, audio vector may each be concatenated and used to predict speech made by user.

With continued reference to FIG. 1, in some embodiments, automatic speech recognition may require training (i.e., enrollment). In some cases, training an automatic speech recognition model may require an individual speaker to read text or isolated vocabulary. In some cases, a solicitation video may include user prompt 116, the contents of which are known a priori by processor 104. Processor 104 may then train an automatic speech recognition model according to training data which includes audible verbal content correlated to known content. In this way, processor 104 may analyze a person's specific voice and train an automatic speech recognition model to the person's speech, resulting in increased accuracy. Alternatively or additionally, in some cases, processor 104 may include an automatic speech recognition model that is speaker-independent. As used in this disclosure, a “speaker independent” automatic speech recognition process does not require training for each individual speaker. Conversely, as used in this disclosure, automatic speech recognition processes that employ individual speaker specific training are “speaker dependent.”

With continued reference to FIG. 1, in some embodiments, an automatic speech recognition process may perform voice recognition or speaker identification. As used in this disclosure, “voice recognition” refers to identifying a speaker, from audio content, rather than what the speaker is saying. In some cases, processor 104 may first recognize a speaker of verbal audio content and then automatically recognize speech of the speaker, for example by way of a speaker dependent automatic speech recognition model or process. In some embodiments, an automatic speech recognition process can be used to authenticate or verify an identity of a speaker. In some cases, a speaker may or may not include subject. For example, subject may speak within solicitation video, but others may speak as well.

With continued reference to FIG. 1, in some embodiments, an automatic speech recognition process may include one or all of acoustic modeling, language modeling, and statistically-based speech recognition algorithms. In some cases, an automatic speech recognition process may employ hidden Markov models (HMMs). As discussed in greater detail below, language modeling such as that employed in natural language processing applications like document classification or statistical machine translation, may also be employed by an automatic speech recognition process.

With continued reference to FIG. 1, an exemplary algorithm employed in automatic speech recognition may include or even be based upon hidden Markov models. Hidden Markov models (HMMs) may include statistical models that output a sequence of symbols or quantities. HMMs can be used in speech recognition because a speech signal can be viewed as a piecewise stationary signal or a short-time stationary signal. For example, over a short time scale (e.g., 10 milliseconds), speech can be approximated as a stationary process. Speech (i.e., audible verbal content) can be understood as a Markov model for many stochastic purposes.

With continued reference to FIG. 1, in some embodiments HMMs can be trained automatically and may be relatively simple and computationally feasible to use. In an exemplary automatic speech recognition process, a hidden Markov model may output a sequence of n-dimensional real-valued vectors (with n being a small integer, such as 10), at a rate of about one vector every 10 milliseconds. Vectors may consist of cepstral coefficients. A cepstral coefficient requires using a spectral domain. Cepstral coefficients may be obtained by taking a Fourier transform of a short time window of speech yielding a spectrum, decorrelating the spectrum using a cosine transform, and taking first (i.e., most significant) coefficients. In some cases, an HMM may have in each state a statistical distribution that is a mixture of diagonal covariance Gaussians, yielding a likelihood for each observed vector. In some cases, each word, or phoneme, may have a different output distribution; an HMM for a sequence of words or phonemes may be made by concatenating an HMMs for separate words and phonemes.

With continued reference to FIG. 1, in some embodiments, an automatic speech recognition process may use various combinations of a number of techniques in order to improve results. In some cases, a large-vocabulary automatic speech recognition process may include context dependency for phonemes. For example, in some cases, phonemes with different left and right context may have different realizations as HMM states. In some cases, an automatic speech recognition process may use cepstral normalization to normalize for different speakers and recording conditions. In some cases, an automatic speech recognition process may use vocal tract length normalization (VTLN) for male-female normalization and maximum likelihood linear regression (MLLR) for more general speaker adaptation. In some cases, an automatic speech recognition process may determine so-called delta and delta-delta coefficients to capture speech dynamics and might use heteroscedastic linear discriminant analysis (HLDA). In some cases, an automatic speech recognition process may use splicing and a linear discriminate analysis (LDA)-based projection, which may include heteroscedastic linear discriminant analysis or a global semi-tied covariance transform (also known as maximum likelihood linear transform [MLLT]). In some cases, an automatic speech recognition process may use discriminative training techniques, which may dispense with a purely statistical approach to HMM parameter estimation and instead optimize some classification-related measure of training data; examples may include maximum mutual information (MMI), minimum classification error (MCE), and minimum phone error (MPE).

With continued reference to FIG. 1, in some embodiments, an automatic speech recognition process may be said to decode speech (i.e., audible verbal content). Decoding of speech may occur when an automatic speech recognition system is presented with a new utterance and must compute a most likely sentence. In some cases, speech decoding may include a Viterbi algorithm. A Viterbi algorithm may include a dynamic programming algorithm for obtaining a maximum a posteriori probability estimate of a most likely sequence of hidden states (i.e., Viterbi path) that results in a sequence of observed events. Viterbi algorithms may be employed in context of Markov information sources and hidden Markov models. A Viterbi algorithm may be used to find a best path, for example using a dynamically created combination hidden Markov model, having both acoustic and language model information, using a statically created combination hidden Markov model (e.g., finite state transducer [FST] approach).

With continued reference to FIG. 1, in some embodiments, an automatic speech recognition process may employ dynamic time warping (DTW)-based approaches. Dynamic time warping may include algorithms for measuring similarity between two sequences, which may vary in time or speed. For instance, similarities in walking patterns would be detected, even if in one video the person was walking slowly and if in another he or she were walking more quickly, or even if there were accelerations and deceleration during the course of one observation. DTW has been applied to video, audio, and graphics—indeed, any data that can be turned into a linear representation can be analyzed with DTW. In some cases, DTW may be used by an automatic speech recognition process to cope with different speaking (e.g., audible verbal content [e.g., user prompt 116]) speeds. In some cases, DTW may allow processor 104 to find an optimal match between two given sequences (e.g., time series) with certain restrictions. That is, in some cases, sequences can be “warped” non-linearly to match each other. In some cases, a DTW-based sequence alignment method may be used in context of hidden Markov models.

With continued reference to FIG. 1, in some embodiments, an automatic speech recognition process may include a neural network. Neural network may include any neural network, for example those disclosed with reference to FIGS. 6-8. In some cases, neural networks may be used for automatic speech recognition, including phoneme classification, phoneme classification through multi-objective evolutionary algorithms, isolated word recognition, audiovisual speech recognition, audiovisual speaker recognition and speaker adaptation. In some cases. neural networks employed in automatic speech recognition may make fewer explicit assumptions about feature statistical properties than HMMs and therefore may have several qualities making them attractive recognition models for speech recognition. When used to estimate the probabilities of a speech feature segment, neural networks may allow discriminative training in a natural and efficient manner. In some cases, neural networks may be used to effectively classify audible verbal content over short-time interval, for instance such as individual phonemes and isolated words. In some embodiments, a neural network may be employed by automatic speech recognition processes for pre-processing, feature transformation and/or dimensionality reduction, for example prior to HMM-based recognition. In some embodiments, long short-term memory (LSTM) and related recurrent neural networks (RNNs) and Time Delay Neural Networks (TDNN's) may be used for automatic speech recognition, for example over longer time intervals for continuous speech recognition.

With continued reference to FIG. 1, processor 104 may utilize a computer vision model, such as a machine vision system configured to detect specific poses via image processing, image recognition, motion capture, and the like. A computer vision model may be configured to translate visual data (e.g., user movement data 128) based on features and contextual information. Features and contextual information may be identified manually by a professional such as an instructor during model training.

With continued reference to FIG. 1, in some embodiments, processor 104 may be configured to analyze user movement data 128 using machine vision system to determine movement error 172 and/or user ability 168. For the purposes of this disclosure, a “machine vision system” is a type of technology that enables a computing device to inspect, evaluate and identify still or moving images. For example, in some cases a machine vision system may be used for world modeling or registration of objects within a space. In some cases, registration may include image processing, such as without limitation object recognition, feature detection, edge/corner detection, and the like. Non-limiting example of feature detection may include scale invariant feature transform (SIFT), Canny edge detection, Shi Tomasi corner detection, and the like. In some cases, a machine vision process may operate image classification and segmentation models, such as without limitation by way of machine vision resource (e.g., OpenMV or TensorFlow Lite). A machine vision process may detect motion, for example by way of frame differencing algorithms. A machine vision process may detect markers, for example blob detection, object detection, face detection, and the like. In some cases, a machine vision process may perform eye tracking (i.e., gaze estimation). In some cases, a machine vision process may perform person detection, for example by way of a trained machine learning model. In some cases, a machine vision process may perform motion detection (e.g., camera motion and/or object motion), for example by way of optical flow detection. In some cases, machine vision process may perform code (e.g., barcode) detection and decoding. In some cases, a machine vision process may additionally perform image capture and/or video recording.

With continued reference to FIG. 1, in some cases, registration may include one or more transformations to orient a camera frame (or an image or video stream) relative a three-dimensional coordinate system; exemplary transformations include without limitation homography transforms and affine transforms. In an embodiment, registration of first frame to a coordinate system may be verified and/or corrected using object identification and/or computer vision, as described above. For instance, and without limitation, an initial registration to two dimensions, represented for instance as registration to the x and y coordinates, may be performed using a two-dimensional projection of points in three dimensions onto a first frame, however. A third dimension of registration, representing depth and/or a z axis, may be detected by comparison of two frames; for instance, where first frame includes a pair of frames captured using a pair of cameras (e.g., stereoscopic camera also referred to in this disclosure as stereo-camera), image recognition and/or edge detection software may be used to detect a pair of stereoscopic views of images of an object; two stereoscopic views may be compared to derive z-axis values of points on object permitting, for instance, derivation of further z-axis points within and/or around the object using interpolation. This may be repeated with multiple objects in field of view, including without limitation environmental features of interest identified by object classifier and/or indicated by an operator. In an embodiment, x and y axes may be chosen to span a plane common to two cameras used for stereoscopic image capturing and/or an xy plane of a first frame; a result, x and y translational components and ϕ may be pre-populated in translational and rotational matrices, for affine transformation of coordinates of object, also as described above. Initial x and y coordinates and/or guesses at transformational matrices may alternatively or additionally be performed between first frame and second frame, as described above. For each point of a plurality of points on object and/or edge and/or edges of object as described above, x and y coordinates of a first stereoscopic frame may be populated, with an initial estimate of z coordinates based, for instance, on assumptions about object, such as an assumption that ground is substantially parallel to an xy plane as selected above. Z coordinates, and/or x, y, and z coordinates, registered using image capturing and/or object identification processes as described above may then be compared to coordinates predicted using initial guess at transformation matrices; an error function may be computed using by comparing the two sets of points, and new x, y, and/or z coordinates, may be iteratively estimated and compared until the error function drops below a threshold level.

With continued reference to FIG. 1, alternatively or additionally, identifying a shape of user movement data 128 may include classifying the shape of user movement data 128 to a label of user movement data 128 using an image classifier; the image classifier may be trained using a plurality of images of user movements. Image classifier may be configured to determine which of a plurality of edge-detected shapes is closest to an attribute set of user movement data 128 as determined by training using training data and selecting the determined shape as user movement data 128. As a non-limiting example, image classifier may be trained with image training data that correlates the plurality of images of user movement data 128 to a label of the user movement data 128. For example and without limitation, image training data may correlate a plurality of images of a user doing a Downward dog pose to a label of ‘Downward dog pose.’ Image classifier and image training data disclosed herein are described further below. Alternatively, identification of user movement data 128 may be performed without using computer vision and/or classification; for instance, identifying user movement data 128 may further include receiving, from a user, an identification of a label of user movement data 128.

With continued reference to FIG. 1, memory 108 contains instructions configuring processor 104 to transmit fitness content 144 to user device 120. In a non-limiting example, processor 104 may transmit fitness content 144 to a plurality of user devices 120. In some embodiments, processor 104 may be further configured to generate a user interface displaying user data 112, user prompt 116, user movement data 128, class data 132, class information 136, instructor data 140, user avatar 188, user ability 168, movement error 172, predefined movement images 180, movement modifier 184, fitness content 144, and the like. For the purposes of this disclosure, a “user interface” is a means by which a user and a computer system interact; for example through the use of input devices and software. A user interface may include a graphical user interface (GUI), command line interface (CLI), menu-driven user interface, touch user interface, voice user interface (VUI), form-based user interface, any combination thereof and the like. In some embodiments, user interface may operate on and/or be communicatively connected to a decentralized platform, metaverse, and/or a decentralized exchange platform associated with the user. For example, a user may interact with user interface in virtual reality. In some embodiments, a user may interact with the use interface using a computing device distinct from and communicatively connected to at least a processor 104. For example, a smart phone, smart, tablet, or laptop operated by a user. In an embodiment, user interface may include a graphical user interface. A “graphical user interface,” as used herein, is a graphical form of user interface that allows users to interact with electronic devices. In some embodiments, GUI may include icons, menus, other visual indicators or representations (graphics), audio indicators such as primary notation, and display information and related user controls. A menu may contain a list of choices and may allow users to select one from them. A menu bar may be displayed horizontally across the screen such as pull-down menu. When any option is clicked in this menu, then the pull-down menu may appear. A menu may include a context menu that appears only when the user performs a specific action. An example of this is pressing the right mouse button. When this is done, a menu may appear under the cursor. Files, programs, web pages and the like may be represented using a small picture in a graphical user interface. For example, links to decentralized platforms as described in this disclosure may be incorporated using icons. Using an icon may be a fast way to open documents, run programs etc. because clicking on them yields instant access.

With continued reference to FIG. 1, in some cases, processor 104 may be configured to receive user movement data 128 of user data 112. For the purposes of this disclosure, “user movement data” is data related to user's motion while taking a fitness class. In some cases, processor 104 may receive user movement data 128 of user data 112 as a function of fitness content 144. As a non-limiting example, user movement data 128 may include an image, audio, video, or the like of a user following instructions provided by fitness content 144. In some embodiments, user movement data 128 may be stored in fitness database 124. In some embodiments, processor 104 may retrieve user movement data 128 from fitness database 124 or user may manually input user movement data 128 into processor 104. As a non-limiting example, processor 104 may receive user movement data 128 from camera of user device 120, instructor device, camera in a fitness classroom, or the like.

With continued reference to FIG. 1, in some cases, user/instructor/third-party avatar may be registered, by processor 104, to a view feed using computer vision model. In some embodiments, processor 104 may generate user avatar 188 as a function of user movement data 128 and transmit user avatar to user device 120. For the purposes of this disclosure, an “user avatar” is a virtual avatar of a user. In another embodiment, the AR device may display a third-party avatar to the user. For the purposes of this disclosure, an “third-party avatar” is a virtual avatar of a third party. For the purposes of this disclosure, “third party” is a person taking a fitness class other than a user that is taking the fitness class. In another embodiment, AR device or user device 120 may display an instructor avatar to the user. For the purposes of this disclosure, an “instructor avatar” is a virtual avatar of an instructor. A “virtual avatar” as used in this disclosure is any digital creation displayed through a screen. Digital creations may include, but are not limited to, digital entities, virtual objects, and the like. The virtual avatar may be a visual representation of a user, an instructor, and/or a third party. The virtual avatar may include, without limitation, two-dimensional representations of animals and/or human characters, three-dimensional representations of animals and/or human characters, and the like. For instance and without limitation, the virtual avatar may include penguins, wolves, tigers, frogs, young human characters, old human characters, middle-aged human characters, and the like. In some embodiments, the virtual avatar may include clothing, apparel, and/or other items. Clothing may include, but is not limited to, jackets, pants, shirts, shorts, suits, ties, and the like. Apparel may include, but is not limited to, skis, ski goggles, baseball mitts, tennis rackets, suitcases, and the like. The virtual avatar may be generated as a function of user image data and/or instructor image data. For instance, and without limitation, processor 104 may generate a user avatar 188 that corresponds to a user. For instance and without limitation, the processor 104 may generate a third-party avatar that corresponds to a third party. For instance, and without limitation, the processor 104 may generate an instructor avatar that corresponds to an instructor. In some embodiments, user avatar 188 may be stored in fitness database 124. In some embodiments, processor 104 may retrieve user avatar 188 from fitness database 124 or user may manually input user avatar 188 into processor 104.

With continued reference to FIG. 1, as used herein, “registration” of an avatar or any other visual elements to a view feed means identifying a location within the view feed of each pixel of each visual element or virtual avatar. Registration may be done with respect to a field coordinate system. As used herein, a “field coordinate system,” is a coordinate system of a view feed, such as a Cartesian coordinate system a polar coordinate system, or the like. Registration of a frame to a view feed may be characterized as a map associating each pixel of a frame, and/or coordinates thereof in a frame coordinate system, to a pixel of field coordinate system. Such mapping may result in a two-dimensional projection of corresponding three-dimensional coordinates on one or more two-dimensional images. For example, registration of a 2D visual element may be done by identifying a region of a field coordinate system that matches the dimensions of the visual element and displaying the visual element in that region (such as when a visual element is intended to be displayed relative to a user's field of view regardless of user movement). As another example, registration of a 3D element may be done by rendering the 3D element as voxels, taking a projection of the voxels on the field coordinate system, and displaying the projection (such as when display of a 3D visual element is desired). As another example, registration of an avatar or a visual element may be done by rendering the avatar or the visual element in a location relative to an object, taking a projection of the avatar on a field coordinate system, and displaying the projection (such as when rendering text describing instructions to an example yoga pose beside the virtual avatar iteratively performing the example yoga pose is desired). In some embodiments, registration of an avatar or a visual element may change from frame to frame. For example, if display of a rotating 3D visual element is desired, then a projection of the avatar or the visual element may differ from frame to frame, such as due to a change in the perspective of a user relative to the rotating element. As another example, display of an avatar or a visual element may change if the avatar or the visual element is displayed relative to an object, and a user/user avatar moves relative to the object.

With continued reference to FIG. 1, in some embodiments, processor 104 may determine an movement error 172 as a function of user movement data 128 and predefined movement images 180. For the purposes of this disclosure, an “movement error” is any user movement data that deviates from the intended form or alignment. As a non-limiting example, movement error 172 may include Boolean value, for example, wrong movement/correct movement, wrong position/correct position, or the like. As another non-limiting example, movement error 172 may include minor error, major error, or the like. In some embodiments, movement error 172 may be stored in fitness database 124. In some embodiments, processor 104 may retrieve movement error 172 from fitness database 124 or user may manually input movement error 172 into processor 104.

With continued reference to FIG. 1, in some embodiments, analyzing user movement data 128 may include matching user movement data 128 to predefined movement images 180. For the purposes of this disclosure, a “predefined movement image” is the visual element that illustrates the ideal alignment or posture of following instructions from a fitness class. As a non-limiting example, predefined movement images 180 may include images or videos that illustrates a person (e.g., instructor) the ideal alignment or posture of demonstrating instructions of fitness content 144. For example, and without limitation, processor 104 may be configured to link certain image and/or video clips of user movement data 128 to certain class content such as a pose and/or instructions to the pose of predefined movement images 180. In some embodiments, fitness content 144 may include predefine movement images 180. In some embodiments, predefined movement images 180 may be stored in fitness database 124. In some embodiments, processor 104 may retrieve predefined movement images 180 from fitness database 124 or user may manually input predefined movement images 180 into processor 104.

With continued reference to FIG. 1, in some embodiments, analyzing user movement data 128 may include fragmenting user movement data 128. For example, processor 104 may be configured to break a recorded training session into modular sections that can be categorized (such as via a classifier) and/or rearranged for further processing steps described below. In some embodiments, user movement data 128 may be fragmented based on a change in categorization using a machine-learning module 156. In some embodiments, user movement data 128 may be fragmented based on user or instructor input. In some embodiments, processor 104 may determine movement error 172 using machine vision system, image classifier, or the like as described above.

With continued reference to FIG. 1, processor 104 may be configured to determine a movement modifier 184 based on an analysis of user movement data 128 (e.g., movement error 172, user ability 168, or the like). In some embodiments, processor 104 may determine or generate movement modifier 184 using a machine-learning module 156. As used herein, a “movement modifier” is an element of data related to a change in user movement data. In some embodiments, fitness content 144 may include movement modifier 184. Movement modifier 184 may indicate that a modification in fitness content 144 is needed. For example, movement modifier 184 may indicate that additional guidance as to how to perform a pose is necessary. As another example, movement modifier 184 may indicate that a pre-planned video or audio segment should be replaced by an alternate element of fitness content 144, such as an element of fitness content 144 that provides additional guidance as to how to perform a pose. As another example, movement modifier 184 may indicate that an element of fitness content 144, such as one that provides additional guidance, should be inserted between pre-planned video or audio segments. As another example, movement modifier 184 may indicate that a historical tutorial video should be displayed in a picture in picture format.

With continued reference to FIG. 1, movement modifier 184 may be determined based on categorization of user movement data 128, such as categorization by a machine-learning model. For example, if a machine-learning model categorizes user movement data 128 as data associated with an instruction to perform a pose, then movement modifier 184 for displaying an instructional video on performing that pose may be determined.

With continued reference to FIG. 1, as another example, and without limitation, movement modifier 184 may include language guidance, such as a warning to an instructor that their description is too complicated. Language guidance may use the output of a language model described above. In an embodiment, user movement data 128 is input into a language model and the language model outputs an interpretation of speech included in the user movement data 128 (for example, a language model may output a text transcript of an instructor's speech). Such an output may be used to determine the statistical prevalence of a word or phrase used by a class user, such as an instructor. Low statistical prevalence may be associated with difficult to understand instruction. For example, if an instructor uses a low statistical prevalence word, then the instructor may be notified that the word is complex and may not be understood. In some embodiments, an apparatus identifies a higher statistical prevalence word or phrase to use to substitute a low statistical prevalence word or phrase. In a non-limiting example, if an instructor uses a low statistical prevalence word or phrase, an apparatus may identify a higher statistical prevalence word or phrase that has the same meaning or a similar meaning and may display to the instructor a suggestion to use the higher statistical prevalence word or phrase. In some embodiments, an apparatus identifies a lower statistical prevalence word or phrase to use to substitute a high statistical prevalence word or phrase, such as if higher variety is desired. In a non-limiting example, if an instructor uses a high statistical prevalence word or phrase, an apparatus may identify a lower statistical prevalence word or phrase that has the same meaning or a similar meaning and may display to the instructor a suggestion to use the lower statistical prevalence word or phrase. In some embodiments, an apparatus may identify an alternative word or phrase, such as a higher or lower prevalence word or phrase and may determine movement modifier 184 as a function of the alternative word or phrase.

With continued reference to FIG. 1, in some embodiments, movement modifier 184 may include an actuator command 192. For the purposes of this disclosure, an “actuator command” is a set of instructions actuating an instructing device. As a non-limiting example, actuator command 192 may actuate instructing device 196 to interact with user to correct movement error 172 as a function of movement modifier 184. In some embodiments, actuator command 192 may be configured to control a plurality of actuators of instructing device 196. As a non-limiting example, if movement modifier 184 includes ‘adjusting the angle of legs of a user,’ then actuator command 192 may include a command for actuators 198 of instructing device 196 to move to interact with the user to guide the user to change the angle of the legs. For example, and without limitation, instructing device 196 may gently touch the user's legs to adjust the angle of the legs. For the purposes of this disclosure, an “instructing device” is an automated device or system equipped with software and hardware components designed to lead and guide participants through a fitness class. As a non-limiting example, instructing device 196 may include a humanoid device. As another non-limiting example, instructing device 196 may include any automated devices that can aid in instructing a fitness class using fitness content 144 and/or movement modifier 184. For the purposes of this disclosure, an “actuator” is a component of a machine that is responsible for moving and/or controlling a mechanism or system. Actuator 198 may, in some cases, require a control signal and/or a source of energy or power. In some cases, a control signal may be relatively low energy. Exemplary control signal forms include electric potential or current, pneumatic pressure or flow, or hydraulic fluid pressure or flow, mechanical force/torque or velocity, or even human power. In some cases, actuator 198 may have an energy or power source other than control signal. This may include a main energy source, which may include for example electric power, hydraulic power, pneumatic power, mechanical power, and the like. In some cases, upon receiving a control signal, actuator 198 may respond by converting source power into mechanical motion. In some cases, actuator 198 may be understood as a form of automation or automatic control.

With continued reference to FIG. 1, in some embodiments, processor 104 may determine a user ability 168 as a function of user data 112. For the purposes of this disclosure, a “user ability” is the quantitative or qualitative measure of the individual's proficiency, readiness, or capability to participate in a fitness class effectively and safely. As a non-limiting example, user ability 168 may include beginner, average, expert, or the like. As another non-limiting example, user ability 168 may include numerical values. In some embodiments, user ability 168 may include a physical ability. For the purposes of this disclosure, a “physical ability” is the quantitative and qualitative assessment of the individual's physiological readiness and capabilities to participate in a fitness class effectively and safely. In some embodiments, user ability 168 may include a mental ability. For the purposes of this disclosure, a “mental ability” is the quantitative and qualitative assessment of the individual's mental readiness and capabilities to participate in a fitness class effectively and safely. In some embodiments, user ability 168 may be stored in fitness database 124. In some embodiments, processor 104 may receive user ability 168 from fitness database 124 or user or instructor may manually input user ability 168 into processor 104.

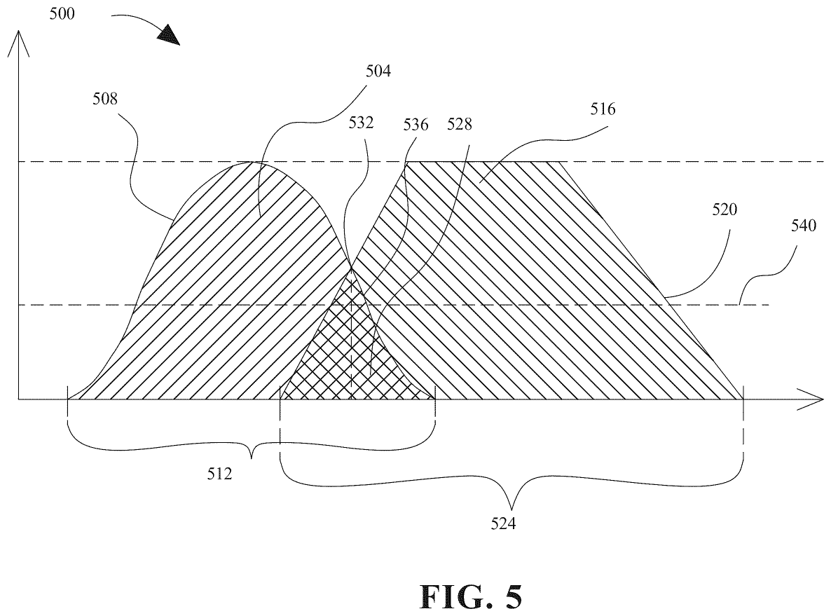

With continued reference to FIG. 1, in some embodiments, processor 104 may determine user ability 168 using an ability machine-learning model of machine-learning module 156. In some embodiments, processor 104 may determine user ability 168 using a fuzzy inference system as described with respect to FIG. 5. In some embodiments, processor 104 may be configured to generate ability training data. In a non-limiting example, ability training data may include correlations between exemplary user movement data, exemplary user data, and/or exemplary user abilities. In some embodiments, ability training data may be stored in fitness database 124. In some embodiments, ability training data may be received from one or more users, fitness database 124, external computing devices, and/or previous iterations of processing. As a non-limiting example, ability training data may include instructions from a user, who may be an expert user, a past user in embodiments disclosed herein, or the like, which may be stored in memory and/or stored in fitness database 124, where the instructions may include labeling of training examples. In some embodiments, ability training data may be updated iteratively using a feedback loop. As a non-limiting example, processor 104 may update ability training data iteratively through a feedback loop as a function of user data 112, user movement data 128 user ability 168, or the like. In some embodiments, processor 104 may be configured to generate ability machine-learning model of machine-learning module 156. In a non-limiting example, generating ability machine-learning model may include training, retraining, or fine-tuning ability machine-learning model using ability training data or updated ability training data. In some embodiments, processor 104 may be configured to determine user ability 168 using ability machine-learning model (i.e. trained or updated ability machine-learning model). In some embodiments, user, user data 112 or user movement data 128 may be classified to a user cohort using a cohort classifier. Cohort classifier may be consistent with any classifier discussed in this disclosure. In some embodiments, a user, user data 112 or user movement data 128 may be classified to a user cohort and processor 104 may determine user ability 168 based on the user cohort using machine-learning module 156 and the resulting output may be used to update ability training data. In some embodiments, generating training data and training machine-learning models may be simultaneous. In some embodiments, processor 104 may generate user ability 168 using a fuzzy inference system.

With continued reference to FIG. 1, in some embodiments, processor 104 may generate movement modifier 184 as a function of user ability 168. As a non-limiting example, processor 104 may generate movement modifier 184 that considers user's ability to perform a fitness class. For example, and without limitation, processor 104 may generate harder movement modifier 184 for users that have high user ability 168. For example, and without limitation, processor 104 may generate easier movement modifier 184 for users that have low user ability 168.

With continued reference to FIG. 1, in some embodiments, processor 104 may generate a classroom timetable as a function of fitness content 144. For the purposes of this disclosure, a “classroom timetable” is a schedule planned for a fitness class in a fitness classroom. In some embodiments, classroom timetable may include months, days, hours, minutes, and the like. As a non-limiting example, classroom timetable may include January, February, March, April, May, June, July, August, September, October, November, December, and the like. As another non-limiting example, classroom timetable may include Monday, Tuesday, Wednesday, Thursday, Friday, Saturday, Sunday, and the like. As another non-limiting example, classroom timetable may include a time slot for 24 hours of a day. For the purposes of this disclosure, a “time slot” is a conventionally defined time interval in a schedule. In some embodiments, classroom timetable may include a personalized timetable. For the purposes of this disclosure, a “personalized timetable” is a fitness classroom schedule that is generated for a specific user. In some embodiments, processor 104 may generate a personalized timetable as a function of user information of user data 112 and classroom information or class information of class data 132. Additional disclosure related to classroom timetable may be found in U.S. patent application Ser. No. 18/368,915, filed on Sep. 15, 2023, and titled “APPARATUS FOR CLASSROOM SCHEDULING AND METHOD OF USE,” having an attorney docket number of 1455-003USU1, the entirety of which is hereby incorporated by reference.

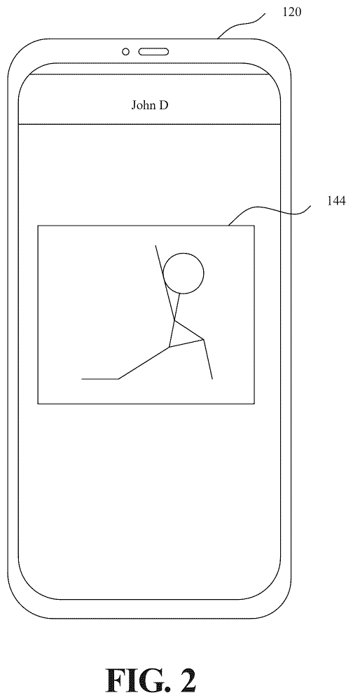

Referring now to FIG. 2, an exemplary user device 120 displaying fitness content 144 is illustrated. As a non-limiting example, user device 120 may include a smartphone, laptop, tablet, smart watch, smart glasses, and the like. In some embodiments, user device 120 may display fitness content 144, user avatar 188, or the like. In some embodiments, user may interact with fitness content 144 using a user interface. In some embodiments, user may input user prompt 116 using user device 120. In some embodiments, user device 120 may display movement modifier 184. These may be implemented with reference to FIG. 1.

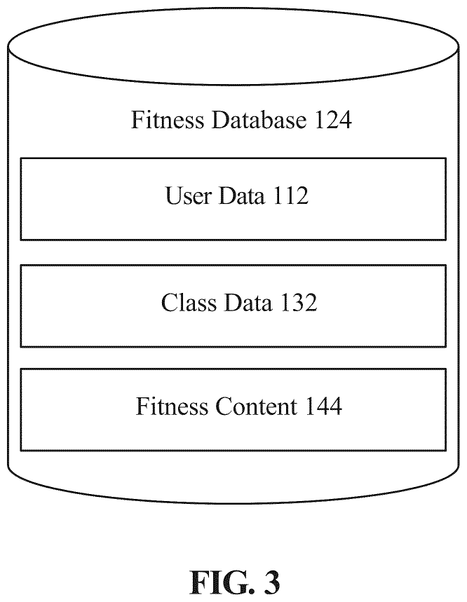

Referring now to FIG. 3, a block diagram of an exemplary fitness database 124 is illustrated. In some embodiments, fitness database 124 may store information related to user data 112. As a non-limiting example, fitness database 124 may store user prompt 116, user information, user movement data 128, user ability 168, predefined movement images 180, movement error 172, movement modifier 184, actuator command 192, or the like. In some embodiments, fitness database 124 may store information related to class data 132. As a non-limiting example, fitness database 124 may store class information 136, classroom information, instructor data 140, or the like. In some embodiments, fitness database 124 may store information related to fitness content 144. As a non-limiting example, fitness database 124 may store content parameter 152, content fragment 148, content duration 176, user avatar 188, input and output of content machine-learning model 160, content training data 164, or the like. In some embodiments, fitness database 124 may store information related to machine-learning module 156. As a non-limiting example, fitness database 124 may store input and output of machine-learning models of machine-learning module 156, training data for machine-learning models, or the like.

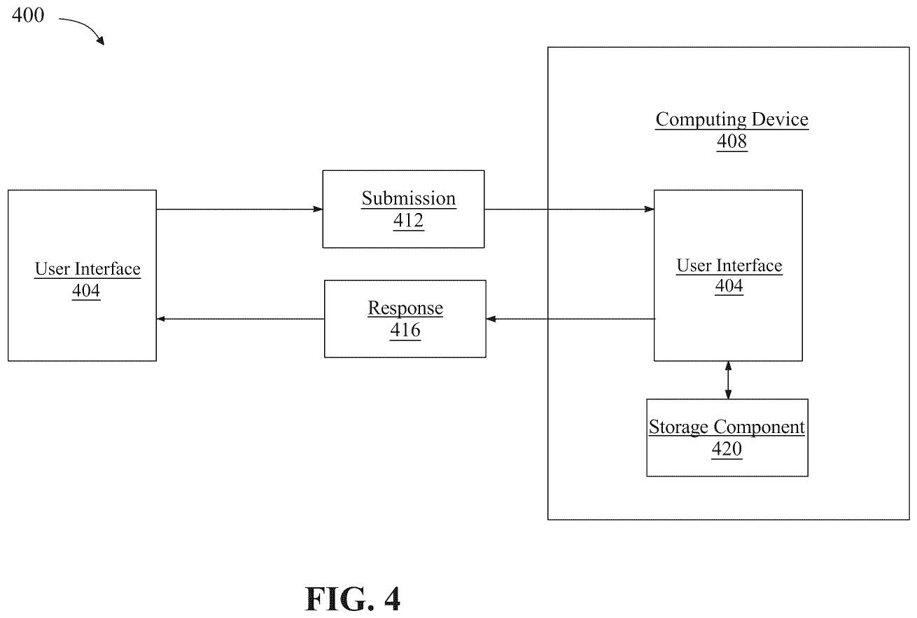

Referring to FIG. 4, a chatbot system 400 is schematically illustrated. According to some embodiments, a user interface 404 may be communicative with a computing device 408 that is configured to operate a chatbot. In some cases, user interface 404 may be local to computing device 408. Alternatively or additionally, in some cases, user interface 404 may remote to computing device 408 and communicative with the computing device 408, by way of one or more networks, such as without limitation the internet. Alternatively or additionally, user interface 404 may communicate with user device 408 using telephonic devices and networks, such as without limitation fax machines, short message service (SMS), or multimedia message service (MMS). Commonly, user interface 404 communicates with computing device 408 using text-based communication, for example without limitation using a character encoding protocol, such as American Standard for Information Interchange (ASCII). Typically, a user interface 404 conversationally interfaces a chatbot, by way of at least a submission 412, from the user interface 408 to the chatbot, and a response 416, from the chatbot to the user interface 404. In many cases, one or both of submission 412 and response 416 are text-based communication. Alternatively or additionally, in some cases, one or both of submission 412 and response 416 are audio-based communication.

Continuing in reference to FIG. 4, a submission 412 once received by computing device 408 operating a chatbot, may be processed by a processor. In some embodiments, processor processes a submission 412 using one or more of keyword recognition, pattern matching, and natural language processing. In some embodiments, processor employs real-time learning with evolutionary algorithms. In some cases, processor may retrieve a pre-prepared response from at least a storage component 420, based upon submission 412. Alternatively or additionally, in some embodiments, processor communicates a response 416 without first receiving a submission 412, thereby initiating conversation. In some cases, processor communicates an inquiry to user interface 404; and the processor is configured to process an answer to the inquiry in a following submission 412 from the user interface 404. In some cases, an answer to an inquiry present within a submission 412 from a user device 404 may be used by computing device 408 as an input to another function.

With continued reference to FIG. 4, a chatbot may be configured to provide a user with a plurality of options as an input into the chatbot. Chatbot entries may include multiple choice, short answer response, true or false responses, and the like. A user may decide on what type of chatbot entries are appropriate. In some embodiments, the chatbot may be configured to allow the user to input a freeform response into the chatbot. The chatbot may then use a decision tree, data base, or other data structure to respond to the users entry into the chatbot as a function of a chatbot input. As used in the current disclosure, “chatbot input” is any response that a user inputs in to a chatbot as a response to a prompt or question.

With continuing reference to FIG. 4, computing device 408 may be configured to the respond to a chatbot input using a decision tree. A “decision tree,” as used in this disclosure, is a data structure that represents and combines one or more determinations or other computations based on and/or concerning data provided thereto, as well as earlier such determinations or calculations, as nodes of a tree data structure where inputs of some nodes are connected to outputs of others. Decision tree may have at least a root node, or node that receives data input to the decision tree, corresponding to at least a candidate input into a chatbot. Decision tree has at least a terminal node, which may alternatively or additionally be referred to herein as a “leaf node,” corresponding to at least an exit indication; in other words, decision and/or determinations produced by decision tree may be output at the at least a terminal node. Decision tree may include one or more internal nodes, defined as nodes connecting outputs of root nodes to inputs of terminal nodes. Computing device 408 may generate two or more decision trees, which may overlap; for instance, a root node of one tree may connect to and/or receive output from one or more terminal nodes of another tree, intermediate nodes of one tree may be shared with another tree, or the like.

Still referring to FIG. 4, computing device 408 may build decision tree by following relational identification; for example, relational indication may specify that a first rule module receives an input from at least a second rule module and generates an output to at least a third rule module, and so forth, which may indicate to computing device 408 an in which such rule modules will be placed in decision tree. Building decision tree may include recursively performing mapping of execution results output by one tree and/or subtree to root nodes of another tree and/or subtree, for instance by using such execution results as execution parameters of a subtree. In this manner, computing device 408 may generate connections and/or combinations of one or more trees to one another to define overlaps and/or combinations into larger trees and/or combinations thereof. Such connections and/or combinations may be displayed by visual interface to user, for instance in first view, to enable viewing, editing, selection, and/or deletion by user; connections and/or combinations generated thereby may be highlighted, for instance using a different color, a label, and/or other form of emphasis aiding in identification by a user. In some embodiments, subtrees, previously constructed trees, and/or entire data structures may be represented and/or converted to rule modules, with graphical models representing them, and which may then be used in further iterations or steps of generation of decision tree and/or data structure. Alternatively or additionally subtrees, previously constructed trees, and/or entire data structures may be converted to APIs to interface with further iterations or steps of methods as described in this disclosure. As a further example, such subtrees, previously constructed trees, and/or entire data structures may become remote resources to which further iterations or steps of data structures and/or decision trees may transmit data and from which further iterations or steps of generation of data structure receive data, for instance as part of a decision in a given decision tree node.

Continuing to refer to FIG. 4, decision tree may incorporate one or more manually entered or otherwise provided decision criteria. Decision tree may incorporate one or more decision criteria using an application programmer interface (API). Decision tree may establish a link to a remote decision module, device, system, or the like. Decision tree may perform one or more database lookups and/or look-up table lookups. Decision tree may include at least a decision calculation module, which may be imported via an API, by incorporation of a program module in source code, executable, or other form, and/or linked to a given node by establishing a communication interface with one or more exterior processes, programs, systems, remote devices, or the like; for instance, where a user operating system has a previously existent calculation and/or decision engine configured to make a decision corresponding to a given node, for instance and without limitation using one or more elements of domain knowledge, by receiving an input and producing an output representing a decision, a node may be configured to provide data to the input and receive the output representing the decision, based upon which the node may perform its decision.

Referring to FIG. 5, an exemplary embodiment of fuzzy set comparison 500 is illustrated. A first fuzzy set 504 may be represented, without limitation, according to a first membership function 508 representing a probability that an input falling on a first range of values 512 is a member of the first fuzzy set 504, where the first membership function 508 has values on a range of probabilities such as without limitation the interval [0,1], and an area beneath the first membership function 508 may represent a set of values within first fuzzy set 504. Although first range of values 512 is illustrated for clarity in this exemplary depiction as a range on a single number line or axis, first range of values 512 may be defined on two or more dimensions, representing, for instance, a Cartesian product between a plurality of ranges, curves, axes, spaces, dimensions, or the like. First membership function 508 may include any suitable function mapping first range 512 to a probability interval, including without limitation a triangular function defined by two linear elements such as line segments or planes that intersect at or below the top of the probability interval. As a non-limiting example, triangular membership function may be defined as:

$$y ( x , a , b , c ) = \{ \begin{matrix}0 , for x > c and x < a \\ \frac{x - a}{b - a} , for a \leq x < b \\ \frac{c - x}{c - b} , if b < x \leq c\end{matrix}$$

a trapezoidal membership function may be defined as:

$$y ( x , a , b , c , d ) = max ( min ( \frac{x - a}{b - a} , 1 , \frac{d - x}{d - c} ) , 0 )$$

a sigmoidal function may be defined as:

$$y ( x , a , c ) = \frac{1}{1 - {e}^{- a ( x - c )}}$$

a Gaussian membership function may be defined as:

$$y ( x , c , σ ) = {e}^{- \frac{1}{2} {( \frac{x - c}{σ} )}^{2}}$$

and a bell membership function may be defined as:

$$y ( x , a , b , c , ) = {[ 1 + {\vert \frac{x - c}{a} \vert}^{2 b} ]}^{- 1}$$

Persons skilled in the art, upon reviewing the entirety of this disclosure, will be aware of various alternative or additional membership functions that may be used consistently with this disclosure.

Still referring to FIG. 5, first fuzzy set 504 may represent any value or combination of values as described above, including output from one or more machine-learning models, user data 112, and a predetermined class, such as without limitation of user ability 168. A second fuzzy set 516, which may represent any value which may be represented by first fuzzy set 504, may be defined by a second membership function 520 on a second range 524; second range 524 may be identical and/or overlap with first range 512 and/or may be combined with first range via Cartesian product or the like to generate a mapping permitting evaluation overlap of first fuzzy set 504 and second fuzzy set 516. Where first fuzzy set 504 and second fuzzy set 516 have a region 528 that overlaps, first membership function 508 and second membership function 520 may intersect at a point 532 representing a probability, as defined on probability interval, of a match between first fuzzy set 504 and second fuzzy set 516. Alternatively or additionally, a single value of first and/or second fuzzy set may be located at a locus 536 on first range 512 and/or second range 524, where a probability of membership may be taken by evaluation of first membership function 508 and/or second membership function 520 at that range point. A probability at 528 and/or 532 may be compared to a threshold 540 to determine whether a positive match is indicated. Threshold 540 may, in a non-limiting example, represent a degree of match between first fuzzy set 504 and second fuzzy set 516, and/or single values therein with each other or with either set, which is sufficient for purposes of the matching process; for instance, threshold may indicate a sufficient degree of overlap between an output from one or more machine-learning models and/or user data 112 and a predetermined class, such as without limitation user ability categorization, for combination to occur as described above. Alternatively or additionally, each threshold may be tuned by a machine-learning and/or statistical process, for instance and without limitation as described in further detail below.

Further referring to FIG. 5, in an embodiment, a degree of match between fuzzy sets may be used to classify user data 112 with user ability 168. For instance, if a user ability 168 has a fuzzy set matching user data 112 fuzzy set by having a degree of overlap exceeding a threshold, processor 104 may classify the user data 112 as belonging to the user ability categorization. Where multiple fuzzy matches are performed, degrees of match for each respective fuzzy set may be computed and aggregated through, for instance, addition, averaging, or the like, to determine an overall degree of match.

Still referring to FIG. 5, in an embodiment, an user data 112 may be compared to multiple user ability categorization fuzzy sets. For instance, user data 112 may be represented by a fuzzy set that is compared to each of the multiple user ability categorization fuzzy sets; and a degree of overlap exceeding a threshold between the user data 112 fuzzy set and any of the multiple user ability categorization fuzzy sets may cause processor 104 to classify the user data 112 as belonging to user ability categorization. For instance, in one embodiment there may be two user ability categorization fuzzy sets, representing respectively high user ability categorization and low user ability categorization. First user ability categorization may have a first fuzzy set; Second user ability categorization may have a second fuzzy set; and user data 112 may have an user data 112 fuzzy set. processor 104, for example, may compare an user data 112 fuzzy set with each of user ability categorization fuzzy set and inuser ability 168 categorization fuzzy set, as described above, and classify a user data 112 to either, both, or neither of user ability categorization or inuser ability 168 categorization. Machine-learning methods as described throughout may, in a non-limiting example, generate coefficients used in fuzzy set equations as described above, such as without limitation x, c, and σ of a Gaussian set as described above, as outputs of machine-learning methods. Likewise, user data 112 may be used indirectly to determine a fuzzy set, as user data 112 fuzzy set may be derived from outputs of one or more machine-learning models that take the user data 112 directly or indirectly as inputs.

Still referring to FIG. 5, a computing device may use a logic comparison program, such as, but not limited to, a fuzzy logic model to determine a user ability 168 response. An user ability 168 response may include, but is not limited to, amateur, beginner, average, knowledgeable, superior, expert, and the like; each such user ability 168 response may be represented as a value for a linguistic variable representing user ability 168 response or in other words a fuzzy set as described above that corresponds to a degree of expertise as calculated using any statistical, machine-learning, or other method that may occur to a person skilled in the art upon reviewing the entirety of this disclosure. In other words, a given element of user data 112 may have a first non-zero value for membership in a first linguistic variable value such as “beginner” and a second non-zero value for membership in a second linguistic variable value such as “expert.” In some embodiments, determining a user ability categorization may include using a linear regression model. A linear regression model may include a machine learning model. A linear regression model may be configured to map data of user data 112, such as degree of expertise to one or more user ability 168 parameters. A linear regression model may be trained using a machine learning process. A linear regression model may map statistics such as, but not limited to, quality of user data expertise. In some embodiments, determining an user ability 168 of user data 112 may include using a user ability 168 classification model. An user ability 168 classification model may be configured to input collected data and cluster data to a centroid based on, but not limited to, frequency of appearance, linguistic indicators of quality, and the like. Centroids may include scores assigned to them such that quality of expertise of user data 112 may each be assigned a score. In some embodiments user ability 168 classification model may include a K-means clustering model. In some embodiments, user ability 168 classification model may include a particle swarm optimization model. In some embodiments, determining the user ability 168 of an user data 112 may include using a fuzzy inference engine. A fuzzy inference engine may be configured to map one or more user data 112 data elements using fuzzy logic. In some embodiments, user data 112 may be arranged by a logic comparison program into user ability 168 arrangement. An “arrangement” as used in this disclosure is any grouping of objects and/or data based on skill level and/or output score. Membership function coefficients and/or constants as described above may be tuned according to classification and/or clustering algorithms. For instance, and without limitation, a clustering algorithm may determine a Gaussian or other distribution of questions about a centroid corresponding to a given expertise level, and an iterative or other method may be used to find a membership function, for any membership function type as described above, that minimizes an average error from the statistically determined distribution, such that, for instance, a triangular or Gaussian membership function about a centroid representing a center of the distribution that most closely matches the distribution. Error functions to be minimized, and/or methods of minimization, may be performed without limitation according to any error function and/or error function minimization process and/or method as described in this disclosure.

Further referring to FIG. 5, an inference engine may be implemented according to input and/or output membership functions and/or linguistic variables. For instance, a first linguistic variable may represent a first measurable value pertaining to user data 112, such as a degree of expertise of an element, while a second membership function may indicate a degree of in user ability 168 of a subject thereof, or another measurable value pertaining to user data 112. Continuing the example, an output linguistic variable may represent, without limitation, a score value. An inference engine may combine rules, such as: “if the difficulty level is ‘hard’ and the popularity level is ‘low’, the question score is ‘high’”—the degree to which a given input function membership matches a given rule may be determined by a triangular norm or “T-norm” of the rule or output membership function with the input membership function, such as min (a, b), product of a and b, drastic product of a and b, Hamacher product of a and b, or the like, satisfying the rules of commutativity (T(a, b)=T(b, a)), monotonicity: (T(a, b)≤T(c, d) if a≤c and b≤d), (associativity: T(a, T(b, c))=T(T(a, b), c)), and the requirement that the number 1 acts as an identity element. Combinations of rules (“and” or “or” combination of rule membership determinations) may be performed using any T-conorm, as represented by an inverted T symbol or “⊥,” such as max (a, b), probabilistic sum of a and b (a+b−a*b), bounded sum, and/or drastic T-conorm; any T-conorm may be used that satisfies the properties of commutativity: ⊥(a, b)=⊥(b, a), monotonicity: ⊥(a, b)≤⊥(c, d) if a≤c and b≤d, associativity: ⊥(a, ⊥(b, c))=⊥(⊥(a, b), c), and identity element of 0. Alternatively or additionally T-conorm may be approximated by sum, as in a “product-sum” inference engine in which T-norm is product and T-conorm is sum. A final output score or other fuzzy inference output may be determined from an output membership function as described above using any suitable defuzzification process, including without limitation Mean of Max defuzzification, Centroid of Area/Center of Gravity defuzzification, Center Average defuzzification, Bisector of Arca defuzzification, or the like. Alternatively or additionally, output rules may be replaced with functions according to the Takagi-Sugeno-King (TSK) fuzzy model.

Further referring to FIG. 5, user data 112 to be used may be selected by user selection, and/or by selection of a distribution of output scores, such as 30% hard/expert, 50% moderate average, and 80% easy/beginner levels or the like. Each user ability categorization may be selected using an additional function such as user ability 168 as described above.

Referring now to FIG. 6, an exemplary embodiment of a machine-learning module 600 that may perform one or more machine-learning processes as described in this disclosure is illustrated. Machine-learning module may perform determinations, classification, and/or analysis steps, methods, processes, or the like as described in this disclosure using machine-learning processes. A “machine-learning process,” as used in this disclosure, is a process that automatedly uses training data 604 to generate an algorithm instantiated in hardware or software logic, data structures, and/or functions that will be performed by a computing device/module to produce outputs 608 given data provided as inputs 612; this is in contrast to a non-machine-learning software program where the commands to be executed are determined in advance by a user and written in a programming language.

Still referring to FIG. 6, “training data,” as used herein, is data containing correlations that a machine-learning process may use to model relationships between two or more categories of data elements. For instance, and without limitation, training data 604 may include a plurality of data entries, also known as “training examples,” each entry representing a set of data elements that were recorded, received, and/or generated together; data elements may be correlated by shared existence in a given data entry, by proximity in a given data entry, or the like. Multiple data entries in training data 604 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 604 according to various correlations; correlations may indicate causative and/or predictive links between categories of data elements, which may be modeled as relationships such as mathematical relationships by machine-learning processes as described in further detail below. Training data 604 may be formatted and/or organized by categories of data elements, for instance by associating data elements with one or more descriptors corresponding to categories of data elements. As a non-limiting example, training data 604 may include data entered in standardized forms by persons or processes, such that entry of a given data element in a given field in a form may be mapped to one or more descriptors of categories. Elements in training data 604 may be linked to descriptors of categories by tags, tokens, or other data elements; for instance, and without limitation, training data 604 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 6, training data 604 may include one or more elements that are not categorized; that is, training data 604 may not be formatted or contain descriptors for some elements of data. Machine-learning algorithms and/or other processes may sort training data 604 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 604 to be made applicable for two or more distinct machine-learning algorithms as described in further detail below. Training data 604 used by machine-learning module 600 may correlate any input data as described in this disclosure to any output data as described in this disclosure. As a non-limiting illustrative example, input data may include user data 112, user prompt 116, user movement data 128, user ability 168, predefined movement images 180, movement error 172, class data 132, class information 136, instructor data 140, output of machine-learning models of machine-learning module 156, or the like. As a non-limiting illustrative example, output data may include user movement data 128, user ability 168, movement error 172, fitness content 144, content parameter 152, or the like.

Further referring to FIG. 6, training data may be filtered, sorted, and/or selected using one or more supervised and/or unsupervised machine-learning processes and/or models as described in further detail below; such models may include without limitation a training data classifier 616. Training data classifier 616 may include a “classifier,” which as used in this disclosure is a machine-learning model as defined below, such as a data structure representing and/or using a mathematical model, neural net, or program generated by a machine-learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. A distance metric may include any norm, such as, without limitation, a Pythagorean norm. Machine-learning module 600 may generate a classifier using a classification algorithm, defined as a processes whereby a computing device and/or any module and/or component operating thereon derives a classifier from training data 604. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 616 may classify elements of training data to user cohort, instructor cohort, class cohort, or the like. For example, and without limitation, training data classifier 616 may classify elements of training data to different age, gender, or the like of user or instructor. For example, and without limitation, training data classifier 616 may classify elements of training data to different size, location, type of class, or the like of fitness classroom.

With continued reference to FIG. 6, computing device may be configured to generate a classifier using a K-nearest neighbors (KNN) algorithm. A “K-nearest neighbors algorithm” as used in this disclosure, includes a classification method that utilizes feature similarity to analyze how closely out-of-sample-features resemble training data to classify input data to one or more clusters and/or categories of features as represented in training data; this may be performed by representing both training data and input data in vector forms, and using one or more measures of vector similarity to identify classifications within training data, and to determine a classification of input data. K-nearest neighbors algorithm may include specifying a K-value, or a number directing the classifier to select the k most similar entries training data to a given sample, determining the most common classifier of the entries in the database, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process as described herein. As a non-limiting example, an initial heuristic may include a ranking of associations between inputs and elements of training data. Heuristic may include selecting some number of highest-ranking associations and/or training data elements.

With continued reference to FIG. 6, generating k-nearest neighbors algorithm may generate a first vector output containing a data entry cluster, generating a second vector output containing an input data, and calculate the distance between the first vector output and the second vector output using any suitable norm such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute l as derived using a Pythagorean norm:

$$l = \sqrt{{\sum }_{i = 0}^{n} {a}_{i}^{2}} ,$$

where aᵢ is attribute number i of the vector. Scaling and/or normalization may function to make vector comparison independent of absolute quantities of attributes, while preserving any dependency on similarity of attributes; this may, for instance, be advantageous where cases represented in training data are represented by different quantities of samples, which may result in proportionally equivalent vectors with divergent values.

With further reference to FIG. 6, training examples for use as training data may be selected from a population of potential examples according to cohorts relevant to an analytical problem to be solved, a classification task, or the like. Alternatively or additionally, training data may be selected to span a set of likely circumstances or inputs for a machine-learning model and/or process to encounter when deployed. For instance, and without limitation, for each category of input data to a machine-learning process or model that may exist in a range of values in a population of phenomena such as images, user data, process data, physical data, or the like, a computing device, processor, and/or machine-learning model may select training examples representing each possible value on such a range and/or a representative sample of values on such a range. Selection of a representative sample may include selection of training examples in proportions matching a statistically determined and/or predicted distribution of such values according to relative frequency, such that, for instance, values encountered more frequently in a population of data so analyzed are represented by more training examples than values that are encountered less frequently. Alternatively or additionally, a set of training examples may be compared to a collection of representative values in a database and/or presented to a user, so that a process can detect, automatically or via user input, one or more values that are not included in the set of training examples. Computing device, processor, and/or module may automatically generate a missing training example; this may be done by receiving and/or retrieving a missing input and/or output value and correlating the missing input and/or output value with a corresponding output and/or input value collocated in a data record with the retrieved value, provided by a user and/or other device, or the like.

Continuing to refer to FIG. 6, computer, processor, and/or module may be configured to preprocess training data. “Preprocessing” training data, as used in this disclosure, is transforming training data from raw form to a format that can be used for training a machine-learning model. Preprocessing may include sanitizing, feature selection, feature scaling, data augmentation and the like.

Still referring to FIG. 6, computer, processor, and/or module may be configured to sanitize training data. “Sanitizing” training data, as used in this disclosure, is a process whereby training examples are removed that interfere with convergence of a machine-learning model and/or process to a useful result. For instance, and without limitation, a training example may include an input and/or output value that is an outlier from typically encountered values, such that a machine-learning algorithm using the training example will be adapted to an unlikely amount as an input and/or output; a value that is more than a threshold number of standard deviations away from an average, mean, or expected value, for instance, may be eliminated. Alternatively or additionally, one or more training examples may be identified as having poor quality data, where “poor quality” is defined as having a signal to noise ratio below a threshold value. Sanitizing may include steps such as removing duplicative or otherwise redundant data, interpolating missing data, correcting data errors, standardizing data, identifying outliers, and the like. In a nonlimiting example, sanitization may include utilizing algorithms for identifying duplicate entries or spell-check algorithms.

As a non-limiting example, and with further reference to FIG. 6, images used to train an image classifier or other machine-learning model and/or process that takes images as inputs or generates images as outputs may be rejected if image quality is below a threshold value. For instance, and without limitation, computing device, processor, and/or module may perform blur detection, and eliminate one or more Blur detection may be performed, as a non-limiting example, by taking Fourier transform, or an approximation such as a Fast Fourier Transform (FFT) of the image and analyzing a distribution of low and high frequencies in the resulting frequency-domain depiction of the image; numbers of high-frequency values below a threshold level may indicate blurriness. As a further non-limiting example, detection of blurriness may be performed by convolving an image, a channel of an image, or the like with a Laplacian kernel; this may generate a numerical score reflecting a number of rapid changes in intensity shown in the image, such that a high score indicates clarity and a low score indicates blurriness. Blurriness detection may be performed using a gradient-based operator, which measures operators based on the gradient or first derivative of an image, based on the hypothesis that rapid changes indicate sharp edges in the image, and thus are indicative of a lower degree of blurriness. Blur detection may be performed using Wavelet-based operator, which takes advantage of the capability of coefficients of the discrete wavelet transform to describe the frequency and spatial content of images. Blur detection may be performed using statistics-based operators take advantage of several image statistics as texture descriptors in order to compute a focus level. Blur detection may be performed by using discrete cosine transform (DCT) coefficients in order to compute a focus level of an image from its frequency content.

Continuing to refer to FIG. 6, computing device, processor, and/or module may be configured to precondition one or more training examples. For instance, and without limitation, where a machine-learning model and/or process has one or more inputs and/or outputs requiring, transmitting, or receiving a certain number of bits, samples, or other units of data, one or more training examples' elements to be used as or compared to inputs and/or outputs may be modified to have such a number of units of data. For instance, a computing device, processor, and/or module may convert a smaller number of units, such as in a low pixel count image, into a desired number of units, for instance by upsampling and interpolating. As a non-limiting example, a low pixel count image may have 100 pixels, however a desired number of pixels may be 128. Processor may interpolate the low pixel count image to convert the 100 pixels into 128 pixels. It should also be noted that one of ordinary skill in the art, upon reading this disclosure, would know the various methods to interpolate a smaller number of data units such as samples, pixels, bits, or the like to a desired number of such units. In some instances, a set of interpolation rules may be trained by sets of highly detailed inputs and/or outputs and corresponding inputs and/or outputs downsampled to smaller numbers of units, and a neural network or other machine-learning model that is trained to predict interpolated pixel values using the training data. As a non-limiting example, a sample input and/or output, such as a sample picture, with sample-expanded data units (e.g., pixels added between the original pixels) may be input to a neural network or machine-learning model and output a pseudo replica sample-picture with dummy values assigned to pixels between the original pixels based on a set of interpolation rules. As a non-limiting example, in the context of an image classifier, a machine-learning model may have a set of interpolation rules trained by sets of highly detailed images and images that have been downsampled to smaller numbers of pixels, and a neural network or other machine-learning model that is trained using those examples to predict interpolated pixel values in a facial picture context. As a result, an input with sample-expanded data units (the ones added between the original data units, with dummy values) may be run through a trained neural network and/or model, which may fill in values to replace the dummy values. Alternatively or additionally, processor, computing device, and/or module may utilize sample expander methods, a low-pass filter, or both. As used in this disclosure, a “low-pass filter” is a filter that passes signals with a frequency lower than a selected cutoff frequency and attenuates signals with frequencies higher than the cutoff frequency. The exact frequency response of the filter depends on the filter design. Computing device, processor, and/or module may use averaging, such as luma or chroma averaging in images, to fill in data units in between original data units.

In some embodiments, and with continued reference to FIG. 6, computing device, processor, and/or module may down-sample elements of a training example to a desired lower number of data elements. As a non-limiting example, a high pixel count image may have 256 pixels, however a desired number of pixels may be 128. Processor may down-sample the high pixel count image to convert the 256 pixels into 128 pixels. In some embodiments, processor may be configured to perform downsampling on data. Downsampling, also known as decimation, may include removing every Nth entry in a sequence of samples, all but every Nth entry, or the like, which is a process known as “compression,” and may be performed, for instance by an N-sample compressor implemented using hardware or software. Anti-aliasing and/or anti-imaging filters, and/or low-pass filters, may be used to clean up side-effects of compression.

Further referring to FIG. 6, feature selection includes narrowing and/or filtering training data to exclude features and/or elements, or training data including such elements, that are not relevant to a purpose for which a trained machine-learning model and/or algorithm is being trained, and/or collection of features and/or elements, or training data including such elements, on the basis of relevance or utility for an intended task or purpose for a trained machine-learning model and/or algorithm is being trained. Feature selection may be implemented, without limitation, using any process described in this disclosure, including without limitation using training data classifiers, exclusion of outliers, or the like.

With continued reference to FIG. 6, feature scaling may include, without limitation, normalization of data entries, which may be accomplished by dividing numerical fields by norms thereof, for instance as performed for vector normalization. Feature scaling may include absolute maximum scaling, wherein each quantitative datum is divided by the maximum absolute value of all quantitative data of a set or subset of quantitative data. Feature scaling may include min-max scaling, in which each value X has a minimum value Xₘᵢₙ in a set or subset of values subtracted therefrom, with the result divided by the range of the values, give maximum value in the set or subset

$${X}_{max} : {X}_{new} = \frac{X - {X}_{min}}{{X}_{max} - {X}_{min}} .$$

Feature scaling may include mean normalization, which involves use of a mean value of a set and/or subset of values, Xₘₑₐₙ with maximum and minimum values:

$${X}_{new} = \frac{X - {X}_{mean}}{{X}_{max} - {X}_{min}} .$$

Feature scaling may include standardization, where a difference between X and Xₘₑₐₙ is divided by a standard deviation σ of a set or subset of values:

$${X}_{new} = \frac{X - {X}_{mean}}{σ} .$$

Scaling may be performed using a median value of a a set or subset X_{median} and/or interquartile range (IQR), which represents the difference between the 25^{th} percentile value and the 50^{th} percentile value (or closest values thereto by a rounding protocol), such as:

$${X}_{new} = \frac{X - {X}_{median}}{I Q R} .$$

Persons skilled in the art, upon reviewing the entirety of this disclosure, will be aware of various alternative or additional approaches that may be used for feature scaling.

Further referring to FIG. 6, computing device, processor, and/or module may be configured to perform one or more processes of data augmentation. “Data augmentation” as used in this disclosure is addition of data to a training set using elements and/or entries already in the dataset. Data augmentation may be accomplished, without limitation, using interpolation, generation of modified copies of existing entries and/or examples, and/or one or more generative AI processes, for instance using deep neural networks and/or generative adversarial networks; generative processes may be referred to alternatively in this context as “data synthesis” and as creating “synthetic data.” Augmentation may include performing one or more transformations on data, such as geometric, color space, affine, brightness, cropping, and/or contrast transformations of images.

Still referring to FIG. 6, machine-learning module 600 may be configured to perform a lazy-learning process 620 and/or protocol, which may alternatively be referred to as a “lazy loading” or “call-when-needed” process and/or protocol, may be a process whereby machine-learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 604. Heuristic may include selecting some number of highest-ranking associations and/or training data 604 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 6, machine-learning processes as described in this disclosure may be used to generate machine-learning models 624. A “machine-learning model,” as used in this disclosure, is a data structure representing and/or instantiating a mathematical and/or algorithmic representation of a relationship between inputs and outputs, as generated using any machine-learning process including without limitation any process as described above, and stored in memory; an input is submitted to a machine-learning model 624 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 624 may be generated by creating an artificial neural network, such as a convolutional neural network comprising an input layer of nodes, one or more intermediate layers, and an output layer of nodes. Connections between nodes may be created via the process of “training” the network, in which elements from a training data 604 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 6, machine-learning algorithms may include at least a supervised machine-learning process 628. At least a supervised machine-learning process 628, as defined herein, include algorithms that receive a training set relating a number of inputs to a number of outputs, and seek to generate one or more data structures representing and/or instantiating one or more mathematical relations relating inputs to outputs, where each of the one or more mathematical relations is optimal according to some criterion specified to the algorithm using some scoring function. For instance, a supervised learning algorithm may include user data 112, user prompt 116, user movement data 128, user ability 168, predefined movement images 180, movement error 172, class data 132, class information 136, instructor data 140, output of machine-learning models of machine-learning module 156, or the like as described above as inputs, user movement data 128, user ability 168, movement error 172, fitness content 144, content parameter 152, or the like as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 604. Persons skilled in the art, upon reviewing the entirety of this disclosure, will be aware of various possible variations of at least a supervised machine-learning process 628 that may be used to determine relation between inputs and outputs. Supervised machine-learning processes may include classification algorithms as defined above.

With further reference to FIG. 6, training a supervised machine-learning process may include, without limitation, iteratively updating coefficients, biases, weights based on an error function, expected loss, and/or risk function. For instance, an output generated by a supervised machine-learning model using an input example in a training example may be compared to an output example from the training example; an error function may be generated based on the comparison, which may include any error function suitable for use with any machine-learning algorithm described in this disclosure, including a square of a difference between one or more sets of compared values or the like. Such an error function may be used in turn to update one or more weights, biases, coefficients, or other parameters of a machine-learning model through any suitable process including without limitation gradient descent processes, least-squares processes, and/or other processes described in this disclosure. This may be done iteratively and/or recursively to gradually tune such weights, biases, coefficients, or other parameters. Updating may be performed, in neural networks, using one or more back-propagation algorithms. Iterative and/or recursive updates to weights, biases, coefficients, or other parameters as described above may be performed until currently available training data is exhausted and/or until a convergence test is passed, where a “convergence test” is a test for a condition selected as indicating that a model and/or weights, biases, coefficients, or other parameters thereof has reached a degree of accuracy. A convergence test may, for instance, compare a difference between two or more successive errors or error function values, where differences below a threshold amount may be taken to indicate convergence. Alternatively or additionally, one or more errors and/or error function values evaluated in training iterations may be compared to a threshold.

Still referring to FIG. 6, a computing device, processor, and/or module may be configured to perform method, method step, sequence of method steps and/or algorithm described in reference to this figure, in any order and with any degree of repetition. For instance, a computing device, processor, and/or module may be configured to perform a single step, sequence and/or algorithm repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. A computing device, processor, and/or module may perform any step, sequence of steps, or algorithm in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Further referring to FIG. 6, machine-learning processes may include at least an unsupervised machine-learning processes 632. An unsupervised machine-learning process, as used herein, is a process that derives inferences in datasets without regard to labels; as a result, an unsupervised machine-learning process may be free to discover any structure, relationship, and/or correlation provided in the data. Unsupervised processes 632 may not require a response variable; unsupervised processes 632 may be used to find interesting patterns and/or inferences between variables, to determine a degree of correlation between two or more variables, or the like.

Still referring to FIG. 6, machine-learning module 600 may be designed and configured to create a machine-learning model 624 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 6, machine-learning algorithms may include, without limitation, linear discriminant analysis. Machine-learning algorithm may include quadratic discriminant analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

Still referring to FIG. 6, a machine-learning model and/or process may be deployed or instantiated by incorporation into a program, apparatus, system and/or module. For instance, and without limitation, a machine-learning model, neural network, and/or some or all parameters thereof may be stored and/or deployed in any memory or circuitry. Parameters such as coefficients, weights, and/or biases may be stored as circuit-based constants, such as arrays of wires and/or binary inputs and/or outputs set at logic “1” and “0” voltage levels in a logic circuit to represent a number according to any suitable encoding system including twos complement or the like or may be stored in any volatile and/or non-volatile memory. Similarly, mathematical operations and input and/or output of data to or from models, neural network layers, or the like may be instantiated in hardware circuitry and/or in the form of instructions in firmware, machine-code such as binary operation code instructions, assembly language, or any higher-order programming language. Any technology for hardware and/or software instantiation of memory, instructions, data structures, and/or algorithms may be used to instantiate a machine-learning process and/or model, including without limitation any combination of production and/or configuration of non-reconfigurable hardware elements, circuits, and/or modules such as without limitation ASICs, production and/or configuration of reconfigurable hardware elements, circuits, and/or modules such as without limitation FPGAs, production and/or of non-reconfigurable and/or configuration non-rewritable memory elements, circuits, and/or modules such as without limitation non-rewritable ROM, production and/or configuration of reconfigurable and/or rewritable memory elements, circuits, and/or modules such as without limitation rewritable ROM or other memory technology described in this disclosure, and/or production and/or configuration of any computing device and/or component thereof as described in this disclosure. Such deployed and/or instantiated machine-learning model and/or algorithm may receive inputs from any other process, module, and/or component described in this disclosure, and produce outputs to any other process, module, and/or component described in this disclosure.

Continuing to refer to FIG. 6, any process of training, retraining, deployment, and/or instantiation of any machine-learning model and/or algorithm may be performed and/or repeated after an initial deployment and/or instantiation to correct, refine, and/or improve the machine-learning model and/or algorithm. Such retraining, deployment, and/or instantiation may be performed as a periodic or regular process, such as retraining, deployment, and/or instantiation at regular elapsed time periods, after some measure of volume such as a number of bytes or other measures of data processed, a number of uses or performances of processes described in this disclosure, or the like, and/or according to a software, firmware, or other update schedule. Alternatively or additionally, retraining, deployment, and/or instantiation may be event-based, and may be triggered, without limitation, by user inputs indicating sub-optimal or otherwise problematic performance and/or by automated field testing and/or auditing processes, which may compare outputs of machine-learning models and/or algorithms, and/or errors and/or error functions thereof, to any thresholds, convergence tests, or the like, and/or may compare outputs of processes described herein to similar thresholds, convergence tests or the like. Event-based retraining, deployment, and/or instantiation may alternatively or additionally be triggered by receipt and/or generation of one or more new training examples; a number of new training examples may be compared to a preconfigured threshold, where exceeding the preconfigured threshold may trigger retraining, deployment, and/or instantiation.

Still referring to FIG. 6, retraining and/or additional training may be performed using any process for training described above, using any currently or previously deployed version of a machine-learning model and/or algorithm as a starting point. Training data for retraining may be collected, preconditioned, sorted, classified, sanitized or otherwise processed according to any process described in this disclosure. Training data may include, without limitation, training examples including inputs and correlated outputs used, received, and/or generated from any version of any system, module, machine-learning model or algorithm, apparatus, and/or method described in this disclosure; such examples may be modified and/or labeled according to user feedback or other processes to indicate desired results, and/or may have actual or measured results from a process being modeled and/or predicted by system, module, machine-learning model or algorithm, apparatus, and/or method as “desired” results to be compared to outputs for training processes as described above.

Redeployment may be performed using any reconfiguring and/or rewriting of reconfigurable and/or rewritable circuit and/or memory elements; alternatively, redeployment may be performed by production of new hardware and/or software components, circuits, instructions, or the like, which may be added to and/or may replace existing hardware and/or software components, circuits, instructions, or the like.

Further referring to FIG. 6, one or more processes or algorithms described above may be performed by at least a dedicated hardware unit 636. A “dedicated hardware unit,” for the purposes of this figure, is a hardware component, circuit, or the like, aside from a principal control circuit and/or processor performing method steps as described in this disclosure, that is specifically designated or selected to perform one or more specific tasks and/or processes described in reference to this figure, such as without limitation preconditioning and/or sanitization of training data and/or training a machine-learning algorithm and/or model. A dedicated hardware unit 636 may include, without limitation, a hardware unit that can perform iterative or massed calculations, such as matrix-based calculations to update or tune parameters, weights, coefficients, and/or biases of machine-learning models and/or neural networks, efficiently using pipelining, parallel processing, or the like; such a hardware unit may be optimized for such processes by, for instance, including dedicated circuitry for matrix and/or signal processing operations that includes, e.g., multiple arithmetic and/or logical circuit units such as multipliers and/or adders that can act simultaneously and/or in parallel or the like. Such dedicated hardware units 636 may include, without limitation, graphical processing units (GPUs), dedicated signal processing modules, FPGA or other reconfigurable hardware that has been configured to instantiate parallel processing units for one or more specific tasks, or the like, A computing device, processor, apparatus, or module may be configured to instruct one or more dedicated hardware units 636 to perform one or more operations described herein, such as evaluation of model and/or algorithm outputs, one-time or iterative updates to parameters, coefficients, weights, and/or biases, and/or any other operations such as vector and/or matrix operations as described in this disclosure.

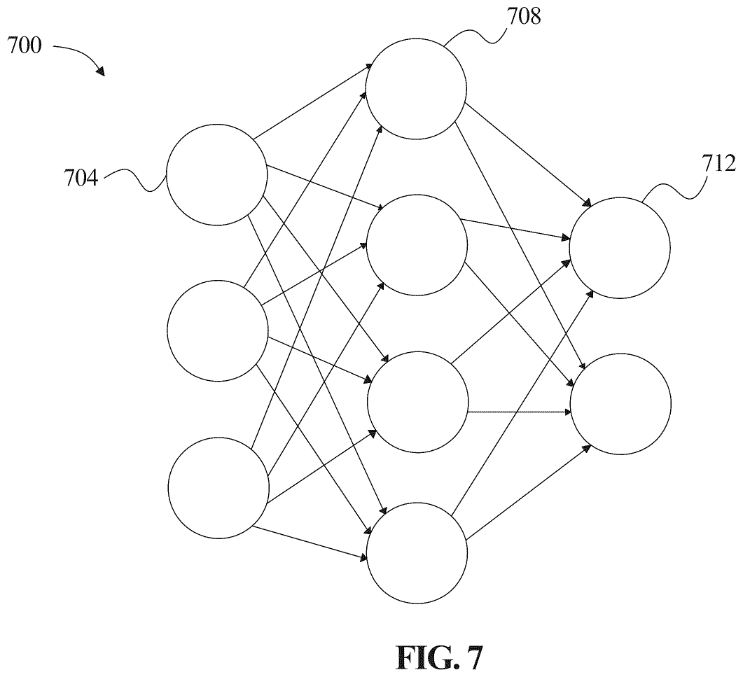

Referring now to FIG. 7, an exemplary embodiment of neural network 700 is illustrated. A neural network 700 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 704, one or more intermediate layers 708, and an output layer of nodes 712. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network, or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

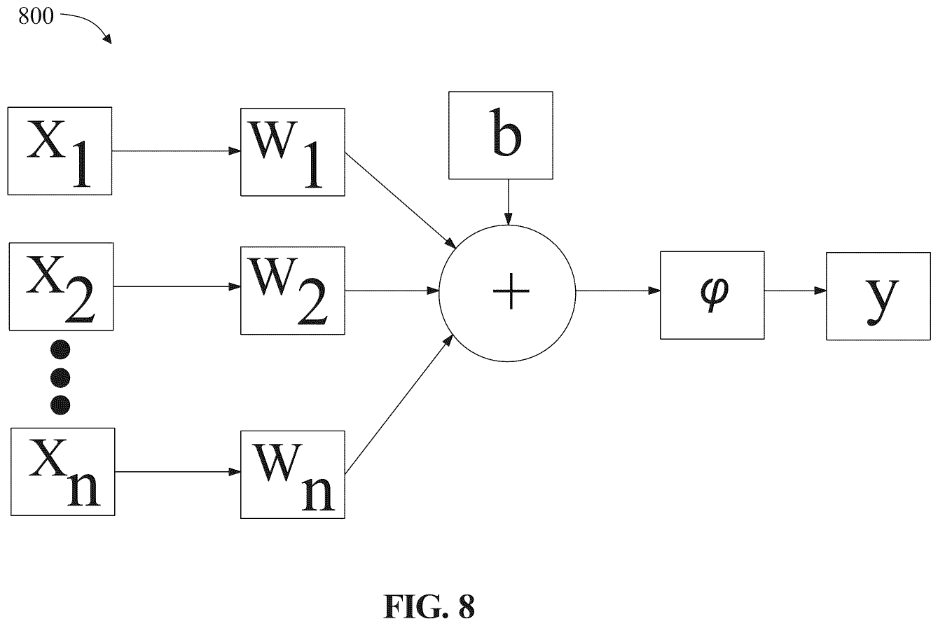

Referring now to FIG. 8, an exemplary embodiment of a node 800 of a neural network is illustrated. A node may include, without limitation, a plurality of inputs x; that may receive numerical values from inputs to a neural network containing the node and/or from other nodes. Node may perform one or more activation functions to produce its output given one or more inputs, such as without limitation computing a binary step function comparing an input to a threshold value and outputting either a logic 1 or logic 0 output or something equivalent, a linear activation function whereby an output is directly proportional to the input, and/or a non-linear activation function, wherein the output is not proportional to the input. Non-linear activation functions may include, without limitation, a sigmoid function of the form

$$f ( x ) = \frac{1}{1 - {e}^{- x}}$$

given a tan h derivative function such input x, a tan h (hyperbolic tangent) function, of the form

$$\frac{{e}^{x} - {e}^{- x}}{{e}^{x} + {e}^{- x}} ,$$

a tan h derivative function such as ƒ(x)=tan h²(x), a rectified linear unit function such as ƒ(x)=max(0, x), a “leaky” and/or “parametric” rectified linear unit function such as ƒ(x)=max(ax, x) for some a, an exponential linear units function such as

$$f ( x ) = \{ \begin{matrix}x for x \geq 0 \\ α ( {e}^{x} - 1 ) for x < 0\end{matrix}$$

for some value of α (this function may be replaced and/or weighted by its own derivative in some embodiments), a softmax function such as

$$f ( {x}_{i} ) = \frac{{e}^{x}}{{\sum }_{i} {x}_{i}}$$

where the inputs to an instant layer are xᵢ, a swish function such as ƒ(x)=x*sigmoid (x), a Gaussian error linear unit function such as ƒ(x)=a(1+tan h (\sqrt{2/π}(x+bx^{r}))) for some values of a, b, and r, and/or a scaled exponential linear unit function such as

$$f ( x ) = λ \{ \begin{matrix}α ( {e}^{x} - 1 ) for x < 0 \\ x for x \geq 0\end{matrix} .$$

Fundamentally, there is no limit to the nature of functions of inputs xᵢ that may be used as activation functions. As a non-limiting and illustrative example, node may perform a weighted sum of inputs using weights wᵢ that are multiplied by respective inputs xᵢ. Additionally or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input xi may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ may be determined by training a neural network using training data, which may be performed using any suitable process as described above.

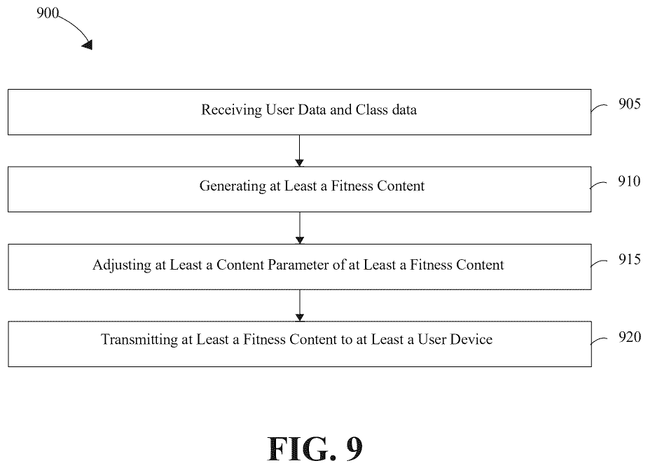

Referring now to FIG. 9, a flow diagram of an exemplary method 900 of automatic fitness content generation using artificial intelligence is illustrated. Method 900 contains a step 905 of receiving, using at least a processor, user data and class data, wherein the user data includes a user prompt. In some embodiments, the class data may include class information and instructor data. These may be implemented with reference to FIGS. 1-8.

With continued reference to FIG. 9, method 900 contains a step 910 of generating, using at least a processor, at least a fitness content using a content machine-learning model of a machine-learning module as a function of class data and user data, wherein generating the at least a fitness content includes generating content training data, wherein the content training data includes correlations between exemplary user data, exemplary class data, and exemplary fitness contents, training the content machine-learning model using the content training data and generating the at least a fitness content using the trained content machine-learning model. These may be implemented with reference to FIGS. 1-8.

With continued reference to FIG. 9, method 900 contains a step 915 of adjusting, using at least a processor, at least a content parameter of at least a fitness content as a function of a user prompt. In some embodiments, the at least a content parameter may include a sequence of content fragments of the at least a fitness content. In some embodiments, the at least a content parameter may include content duration of the at least a fitness content. These may be implemented with reference to FIGS. 1-8.

With continued reference to FIG. 9, method 900 contains a step 920 of transmitting, using at least a processor, at least a fitness content to at least a user device. In some embodiments, method 900 may further include receiving, using the at least a processor, user movement data of the user data as a function of the at least a fitness content from the at least a user device, generating, using the at least a processor, at least a user avatar as a function of the user movement data and transmitting, using the at least a processor, the at least a user avatar to the at least a user device. In some embodiments, method 900 may further include determining, using the at least a processor, a movement error as a function of user movement data and predefined movement images and determining, using the at least a processor, at least a movement modifier as a function of the movement error. In some embodiments, the movement modifier may include an actuator command, wherein the actuator command may be configured to actuate an instructing device to interact with a user. In some embodiments, method 900 may further include determining, using the at least a processor, a user ability as a function of user data, wherein the user ability may include a physical ability and a mental ability and generating, using the at least a processor, the at least a movement modifier as a function of the user ability. These may be implemented with reference to FIGS. 1-8.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

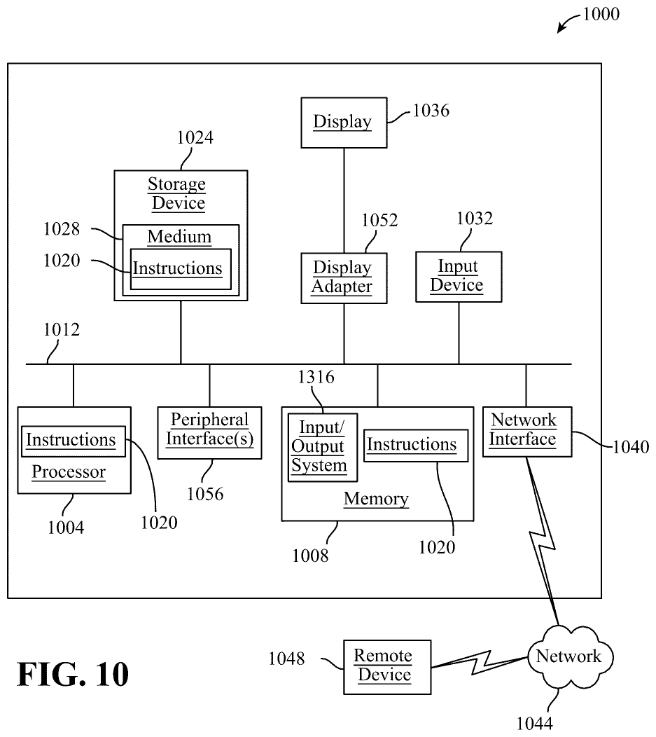

FIG. 10 shows a diagrammatic representation of one embodiment of a computing device in the exemplary form of a computer system 1000 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 1000 includes a processor 1004 and a memory 1008 that communicate with each other, and with other components, via a bus 1012. Bus 1012 may include any of several types of bus structures including, but not limited to, a memory bus, a memory controller, a peripheral bus, a local bus, and any combinations thereof, using any of a variety of bus architectures.

Processor 1004 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 1004 may be organized according to Von Neumann and/or Harvard architecture as a non-limiting example. Processor 1004 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC)

Memory 1008 may include various components (e.g., machine-readable media) including, but not limited to, a random-access memory component, a read only component, and any combinations thereof. In one example, a basic input/output system 1016 (BIOS), including basic routines that help to transfer information between elements within computer system 1000, such as during start-up, may be stored in memory 1008. Memory 1008 may also include (e.g., stored on one or more machine-readable media) instructions (e.g., software) 1020 embodying any one or more of the aspects and/or methodologies of the present disclosure. In another example, memory 1008 may further include any number of program modules including, but not limited to, an operating system, one or more application programs, other program modules, program data, and any combinations thereof.

Computer system 1000 may also include a storage device 1024. Examples of a storage device (e.g., storage device 1024) include, but are not limited to, a hard disk drive, a magnetic disk drive, an optical disc drive in combination with an optical medium, a solid-state memory device, and any combinations thereof. Storage device 1024 may be connected to bus 1012 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1024 (or one or more components thereof) may be removably interfaced with computer system 1000 (e.g., via an external port connector (not shown)). Particularly, storage device 1024 and an associated machine-readable medium 1028 may provide nonvolatile and/or volatile storage of machine-readable instructions, data structures, program modules, and/or other data for computer system 1000. In one example, software 1020 may reside, completely or partially, within machine-readable medium 1028. In another example, software 1020 may reside, completely or partially, within processor 1004.

Computer system 1000 may also include an input device 1032. In one example, a user of computer system 1000 may enter commands and/or other information into computer system 1000 via input device 1032. Examples of an input device 1032 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1032 may be interfaced to bus 1012 via any of a variety of interfaces (not shown) including, but not limited to, a serial interface, a parallel interface, a game port, a USB interface, a FIREWIRE interface, a direct interface to bus 1012, and any combinations thereof. Input device 1032 may include a touch screen interface that may be a part of or separate from display 1036, discussed further below. Input device 1032 may be utilized as a user selection device for selecting one or more graphical representations in a graphical interface as described above.

A user may also input commands and/or other information to computer system 1000 via storage device 1024 (e.g., a removable disk drive, a flash drive, etc.) and/or network interface device 1040. A network interface device, such as network interface device 1040, may be utilized for connecting computer system 1000 to one or more of a variety of networks, such as network 1044, and one or more remote devices 1048 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1044, may employ a wired and/or a wireless mode of communication. In general, any network topology may be used. Information (e.g., data, software 1020, etc.) may be communicated to and/or from computer system 1000 via network interface device 1040.

Computer system 1000 may further include a video display adapter 1052 for communicating a displayable image to a display device, such as display device 1036. Examples of a display device include, but are not limited to, a liquid crystal display (LCD), a cathode ray tube (CRT), a plasma display, a light emitting diode (LED) display, and any combinations thereof. Display adapter 1052 and display device 1036 may be utilized in combination with processor 1004 to provide graphical representations of aspects of the present disclosure. In addition to a display device, computer system 1000 may include one or more other peripheral output devices including, but not limited to, an audio speaker, a printer, and any combinations thereof. Such peripheral output devices may be connected to bus 1012 via a peripheral interface 1056. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods and apparatuses according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. An apparatus for automatic fitness content generation using artificial intelligence (AI), the apparatus comprising:
at least a processor; and
a memory communicatively connected to the at least a processor, wherein the memory contains instructions configuring the at least a processor to:
receive user data and class data, wherein the user data comprises a user prompt;
generate at least a fitness content using a content machine-learning model of a machine-learning module as a function of the class data and the user data, wherein generating the at least a fitness content comprises:
generating content training data, wherein the content training data comprises correlations between exemplary user data, exemplary class data, and exemplary fitness contents;
training the content machine-learning model using the content training data; and
generating the at least a fitness content using the trained content machine-learning model;
adjust at least a content parameter of the at least a fitness content as a function of the user prompt; and
transmit the at least a fitness content to at least a user device.

2. The apparatus of claim 1, wherein the class data comprises class information and instructor data.

3. The apparatus of claim 1, wherein the at least a content parameter comprises a sequence of content fragments of the at least a fitness content.

4. The apparatus of claim 1, wherein the at least a content parameter comprises content duration of the at least a fitness content.

5. The apparatus of claim 1, wherein the memory contains instructions further configuring the at least a processor to:
receive user movement data of the user data as a function of the at least a fitness content from the at least a user device;
generate at least a user avatar as a function of the user movement data; and
transmit the at least a user avatar to the at least a user device.

6. The apparatus of claim 6, wherein the memory contains instructions further configuring the at least a processor to:
determine a movement error as a function of the user movement data and predefined movement images; and
determine at least a movement modifier as a function of the movement error.

7. The apparatus of claim 7, wherein the movement modifier comprises an actuator command, wherein the actuator command is configured to actuate an instructing device to interact with a user.

8. The apparatus of claim 1, wherein the memory contains instructions further configuring the at least a processor to:
determine a user ability as a function of the user data, wherein the user ability comprises a physical ability and a mental ability; and
generate the at least a movement modifier as a function of the user ability.

9. A method for automatic fitness content generation using artificial intelligence, the method comprising:
receiving, using at least a processor, user data and class data, wherein the user data comprises a user prompt;
generating, using the at least a processor, at least a fitness content using a content machine-learning model of a machine-learning module as a function of the class data and the user data, wherein generating the at least a fitness content comprises:
generating content training data, wherein the content training data comprises correlations between exemplary user data, exemplary class data, and exemplary fitness contents;
training the content machine-learning model using the content training data; and
generating the at least a fitness content using the trained content machine-learning model;
adjusting, using the at least a processor, at least a content parameter of the at least a fitness content as a function of the user prompt; and
transmitting, using the at least a processor, the at least a fitness content to at least a user device.

10. The method of claim 11, wherein the class data comprises class information and instructor data.

11. The method of claim 11, wherein the at least a content parameter comprises a sequence of content fragments of the at least a fitness content.

12. The method of claim 11, wherein the at least a content parameter comprises content duration of the at least a fitness content.

13. The method of claim 11, further comprising:
receiving, using the at least a processor, user movement data of the user data as a function of the at least a fitness content from the at least a user device;
generating, using the at least a processor, at least a user avatar as a function of the user movement data; and
transmitting, using the at least a processor, the at least a user avatar to the at least a user device.

14. The method of claim 13, further comprising:
determining, using the at least a processor, a movement error as a function of the user movement data and predefined movement images; and
determining, using the at least a processor, at least a movement modifier as a function of the movement error.

15. The method of claim 14, wherein the movement modifier comprises an actuator command, wherein the actuator command is configured to actuate an instructing device to interact with a user.

16. The method of claim 11, further comprising:
determining, using the at least a processor, a user ability as a function of the user data, wherein the user ability comprises a physical ability and a mental ability; and
generating, using the at least a processor, the at least a movement modifier as a function of the user ability.
